(19) United States
(12) Patent Application Publication
(10) Pub. No.: US 2014/0039911 A1
(43) Pub. Date: Feb. 6, 2014

(54) SYSTEM AND METHOD OF COMPARING HEALTHCARE COSTS, FINDING PROVIDERS, AND MANAGING PRESCRIBED TREATMENTS

(71) Applicant: Sriram IYER, North Bethesda, MD (US)

(72) Inventor: Sriram IYER, North Bethesda, MD (US)

(21) Appl. No.: 13/936,614

(22) Filed: Jul. 8, 2013

Related U.S. Application Data
(60) Provisional application No. 61/668,530, filed on Jul. 6, 2012.

(51) Int. Cl. G06Q 50/22; G06Q 30/06

(52) U.S. Cl. CPC G06Q 50/22; G06Q 30/0629
USPC 705/2

(57) ABSTRACT

A medical savings management system, device, and method includes a computing device configured to manage medical savings, including drug therapies, to reduce healthcare costs. Users identify medications and other treatments, determine acceptable alternatives, and identify local health care providers. Users compare costs of the identified treatments from particular local providers based upon contracted discounts, manufacturer rebates, and the availability of lower cost clinical alternatives. Based on the identified treatments, health care providers, and costs, users select a preferred treatment and provider and reduce the cost of the treatment. Additional savings are realized by.by searching a larger radius for lower cost providers and by sharing discount cards using email, text messaging, and social media outlets. Users benefit from the savings and generate revenue for sponsors of the discount programs. The system is integrated with credit, debit and Health Flex cards to facilitate payment and reimbursement for eligible health expenses.

### CROSS-REFERENCE TO RELATED APPLICATIONS

This application claims priority to U.S. Provisional Patent Application No. 61/668,530, filed on Jul. 6, 2012, the entire contents of which are incorporated herein by reference.

### TECHNICAL FIELD

This technology generally relates to computer systems, devices, and methods for managing healthcare costs and prescribed treatments and more specifically to identifying, locating, and managing medication therapies.

### BACKGROUND

Advances in pharmaceutical treatments have transformed health care over the last several decades. Many health problems are prevented, cured, or managed effectively for years through the use of prescription drugs. In some cases, the use of prescription medicines and treatments reduces the need for patients to undergo other expensive health care interventions, such as hospitalization or surgery. As the patient population ages, the likelihood that a patient will have a prescription drug expense also increases. The larger patient population coupled with a substantial increase in the number of medicines being prescribed has resulted in a huge increase in demand for prescription medications and treatments. Prescription drug costs were over $259 billion in 2010, representing more than 10% of health care spending in the U.S. This cost is projected to double over the next decade presenting significant cost implications for the American public, health insurers, and government payers.

Private and public insurers have responded to rising prescription drug costs in a number of ways, including increasing enrollee cost-sharing amounts, using formularies to exclude certain drugs from coverage, applying quantity dispensing limits, requiring prior authorization, and using step therapy strategies where with the most cost-effective drug is used to start treatment and more costly drugs are dispensed only when the cheaper drugs are deemed to be ineffective. Pharmacy Benefit Managers (PBMs), private plans, and Medicaid programs negotiate with pharmacies and pharmaceutical manufacturers to receive pricing discounts and rebates that are applied based on volume, prompt payment, and market share.

Almost all private health insurance plans cover prescription medication. However, there is enormous variation in the drugs that are covered and the share of costs that the insured individual must pay. Employees covered by private health insurance plans pay different cost-sharing amounts for different classifications of drugs. This “tiering” of generic, preferred, and non-preferred classifications can encourage consumers and their providers to use less expensive drugs, but it can be problematic to low-income individuals, who may not be able to afford the higher co-payments charged for preferred medications that usually include brand-name drugs without a generic substitute. Many patients report that they go without or delay filling a prescription medication because of the costs.

Medicaid is the major source of outpatient prescription drugs for the low-income population. While all state Medicaid programs cover prescription drugs, there are many differences in state policies with regard to copayments charged to enrollees, preferred drugs, and the number of prescriptions that can be filled.

Additionally, the Medicare Part D outpatient prescription drug benefit went into effect on Jan. 1, 2006. Before this program, Medicare did not cover prescription drugs, and beneficiaries either obtained coverage through supplemental plans or through Medicaid if they were dually eligible for both programs. In 2011, spending on the Medicare Part D program reached $60 billion. While subsidies are available for low-income seniors for the associated costs of Medicare Part D, some Medicare beneficiaries still incur significant out-of-pocket expenses for their prescription drugs due to a gap in coverage which is often referred to as the Part D “donut hole.”

Access to prescription drug coverage and the resulting use of prescription drugs will be expanded by recent health insurance mandates. Prescription drug coverage is one of the “essential health benefits” that must be included in health plans in state-based health insurance exchanges and in the benchmark benefit packages for newly eligible adults under Medicaid. As healthcare costs continue to grow, patients, employers, insurance companies, and pharmacy benefit managers struggle to manage and control accelerated healthcare costs.

The increased costs to both patients and providers underscore the need to effectively and efficiently explore lower cost treatment alternatives when faced with high prescription medication costs. Prices for prescription drugs vary widely from drugstore to drugstore. Prices for medical treatments vary widely from treatment facility to treatment facility. Different approaches have been used in the past to attempt to manage prescription drug costs and the cost of medical treatments.

### SUMMARY

In this disclosure, many of the examples discuss systems and methods used to determine, compare, locate, and manage prescribed treatments including prescription drugs and other medical treatments using computing devices on disparate networks. However, it should be understood that the systems and techniques in accordance with the claimed invention can also provide secure transmission, reception, and storage of electronic files and documents within a single computer or a single computer network, depending upon the sending computer and the receiving computer. Additionally, multiple sending and receiving computers can be employed, such as when a patient is a member of a group, such as a group of insured employees, a group of patients sharing similar demographics, and a group of patients utilizing the same pharmacy or healthcare provider, for example. The examples shown and described in this disclosure use English language icons, buttons, keys, and the like as part of a user interface. However, other languages, including Spanish, French, Italian, and others can also be used to display, enter, search, and fully utilize the features and benefits of the claimed invention.

Additionally, while many of the examples in this disclosure discuss prescription drugs and/or medication treatments and therapies, other healthcare supplies, therapies, and procedures are also determined, compared, and managed using the systems, devices, and methods of the claimed invention.

One example of the claimed invention includes a system, device, and method for managing medication therapy, including evaluating and managing savings on prescription drugs, to save on healthcare costs. Users are able to find cost savings on prescription drugs to manage their own medication therapy effectively and to easily find local care givers. For example, users can conduct a search for particular drugs, determine pricing of the drugs at local pharmacies, obtain discounted pricing for most prescription drugs through the benefit of negotiate agreements with select pharmacies, and compare both the retail pricing as well as discounted pricing of the drug at different pharmacies and other providers. The drugs can be compared against clinical, therapeutic, and functional alternatives in terms of dosage, package, manufacturer, effects, price, and other search criteria. The claimed invention utilizes actual discounted price information based upon contracts negotiated with participating and listed pharmacies and actual history of claims from pharmacies nationwide to provide a savings tool that allows users to determine the manner in which to save on healthcare costs and where to go to fill their drug prescriptions and for healthcare treatment. The claimed invention extends pharmacy benefit manager pricing via a prescription discount program to consumers using digital tools without the need to charge insurance premiums or access fees to those consumers.

In one example of the claimed invention, a system, device, and method provides a directory of local healthcare providers and care facilities that users organize by a unique taxonomy to enable users to find the most appropriate nearby care options and/or facilities. The claimed invention can identify types and locations of healthcare providers to be utilized. The directory can be compiled and mapped using a GPS or other location determination techniques of a smartphone or other computing device. The method of the claimed invention allows users and other parties responsible for the financial costs of healthcare coverage to save by accessing provider discounts, investigating alternatives, and utilizing appropriate care sites and alternatives.

In one example of the claimed invention, a system, device, and method enables users to share the techniques and results of their searches and other interactions managing healthcare and identifying healthcare providers. For example, one example implementation of the claimed invention provides social media and other sharing techniques to share discounts, distribute discount cards, provide comments, feedback, instructions, and the like among communities of users. Users can share information or actual discount coupons, manufacturer discount programs, price-matching offers, price increase notifications, user experiences and recommendations regarding particular healthcare alternatives, and the like. Users can post and read messages, reviews, pictures, text, links, and use other social networking services to manage their healthcare therapies and costs. Users benefit from the experiences and knowledge of other users.

One example of the claimed invention includes a system of medication adherence to ensure compliance with physicians' orders for medication. The claimed invention provides a visual method of tracking medication use, including scheduling and administration of medication, and provides a patient medication log. The claimed invention provides reminders (audio and visual) and summaries of usage, dosage, administration, refills, and compliance. Additional notations, comments, and input, such as photographs and other video, audio, and textual data can be added to the patient medication log as well.

One example of the claimed invention includes a system, device, and method that links a discount card to each drug search, compared and priced by a software application and method. For example, discount cards (or optical scan codes, including QR codes, UPC bar codes, and the like) can be dynamically allocated based upon the drug search, diagnosis, or other user criteria. The discounts cards can be targeted for use at the pharmacies that can be selected as providers of the user's medication. Similarly, blocks of discount codes and discount coupons can be allocated and distributed to users based on similar search and results criteria.

One example of the claimed invention includes a system, device and method that compares the retail, discounted prices for each drug at local pharmacies against the copay an insured patient would otherwise have to pay. In cases where the copay exceeds the discounted price, despite being covered by an insurance plan (including Medicare), the user can access and avail of lower cost prescription drugs

One example of the claimed inventions includes a system, device and method to file a claim against financial accounts that are pre-funded, tax-advantaged or linked to banking, payroll, or other funding sources. Users are able to avail of two levels of discounts. The first is the negotiated discounts that lower the cost of the drug, medical device or service. The second is the tax advantage gained by filing the claim cost against a Health Savings Account (HSA), Health Reimbursement Account (HRA), and/or Flexible Savings Account (FSA). Users also benefit from the convenience of promptly paying from their checking account, payroll account, credit card, or other similar funding source.

One example system includes a server with several specialized databases. The server and databases are connected to a computer network to access user devices. Likewise, the server and databases can be accessed by the user devices. The server also electronically accesses (3^{rd} party) pricing and contract adjudication systems to retrieve discounted pricing data. The server accesses the databases to retrieve data, process requests from the user devices, and otherwise provide healthcare provider cost information, including prescription drug cost information for pharmacies, to the user devices. The server accesses a drug listing database, a prescription frequency database, a pharmacy detail database, a pharmacy claims database, a therapeutic alternative and pricing range database, a provider directory database, a user profile and saved items database, and a contracted drug database to perform methods of the claimed invention.

One example of the claimed invention includes a handheld electronic computing device, such as a cellular phone or a personal media player that can be used to manage medication therapies. Prescription drug information, pharmacy and other healthcare provider information, and the like can be stored on the system and provided to the handheld electronic device. Users of the handheld device can enter and receive data, documents, and files via computer networks, near field communication, and the like. The handheld device can be used to compare prescription medication prices among local pharmacies.

Medical savings information may be managed on the handheld device by a medical savings application. Prescription drugs and location information can be entered into the application via several methods, and the handheld device can retrieve cost and provider information. For example, prescription drug information can be entered by a user typing in a prescription drug of interest through the medication management application. In another embodiment, prescription drug information can be entered via audio input, such as a user speaking the name of the prescription drug, the handheld device recognizing and converting the audio signals to a document or image format. Additional prescription drug cost information retrieval methods may be employed, such as, for example, acquiring digital images of prescription drug documents and extracting prescription drug information via optical character recognition software, barcode-reading software, or QR-code-reading software.

Location information can also be managed via the medication management application. Location information provided by a GPS or other location determining circuitry can be loaded onto the handheld device to determine a location of interest in which to compare prescription drug prices. Additionally, a user can enter location information by user input devices including keypad, via audio input, or by optical input, such as scanning a radio frequency identification tag embedded in an old prescription tag. Once the location information is entered in the handheld device, the corresponding pricing information can be looked up by the system and provided to the handheld device. Other location retrieval methods can also be employed.

These and other advantages, aspects, and features will become more apparent from the following detailed description when viewed in conjunction with the accompanying drawings. A number of non-limiting and non-exhaustive embodiments are described with reference to the following drawings. Accordingly, the drawings and descriptions below are to be regarded as illustrative in nature, and not as restrictive.

### BRIEF DESCRIPTION OF THE DRAWINGS

FIG. 1 is an example computer system configured for managing medical savings in accordance with the claimed invention.

FIGS. 2A illustrates an example process flow algorithm performing a medical savings management method of the claimed invention.

FIG. 2B illustrates a four-layer application architecture in accordance with the system and method of the claimed invention.

FIG. 2C shows example logic, modules, and databases for determining an average price for a prescription drug, medical supply, and medical service in accordance with the claimed invention.

FIG. 2D shows example logic, modules, and databases for determining cost estimates for therapeutic alternatives in accordance with the claimed invention.

FIGS. 3A-3Y are screen shots displayed on a user device as a method of the claimed invention is carried out.

FIG. 4 shows an example computing device for managing medication in accordance with the claimed invention.

### DETAILED DESCRIPTION

When a patient or other user wants to determine the price of a prescription drug or other medical treatment in a particular locality, the patient can enter the drug information and the locality into a device of the claimed invention, and the device will present the user with price and location information for healthcare providers offering the prescription drug. In addition, the device will present discounted pricing for the selected prescription drug at select local pharmacies, which will often be lower than the provider's retail price. Users can compare the prices offered by different healthcare providers for that particular drug. Additionally, users can identify and price clinical, therapeutic, and functional alternatives based on additional search criteria including dosage, package, manufacturer, effects, price, and the like. A directory of healthcare providers is delivered to the users. The directory can be mapped for the users using a GPS or location determination device integral or separate from the device of the claimed invention.

Additionally, the claimed invention provides a second level of discounts for users via tax advantages afforded by “flex cards” that are part of health reimbursement accounts (HRA), health savings accounts (HSA), and/or flexible spending accounts (FSA). Flex cards tied to the system and method of the claimed invention provide users the ability to file a claim and make a payment at the pharmacy or healthcare provider using pretax contributions on the flex cards.

Additionally, the claimed invention provides users the ability to pay for their healthcare expenses using credit cards, debit card, and pre-paid cards.

Further, the claimed invention provides the convenience of evaluating, comparing, and purchasing discount health plans that are not insurance products. The discount health plans extend lower cost rates at specific contracted providers for an access fee. Users may pay a single-use, month-to-month, or 6-month or annual fee to gain access the plan. However, the user bears the full discounted cost of the medical procedure. Such plans are common in Dental, Vision and Chiropractic lines of services.

System Overview

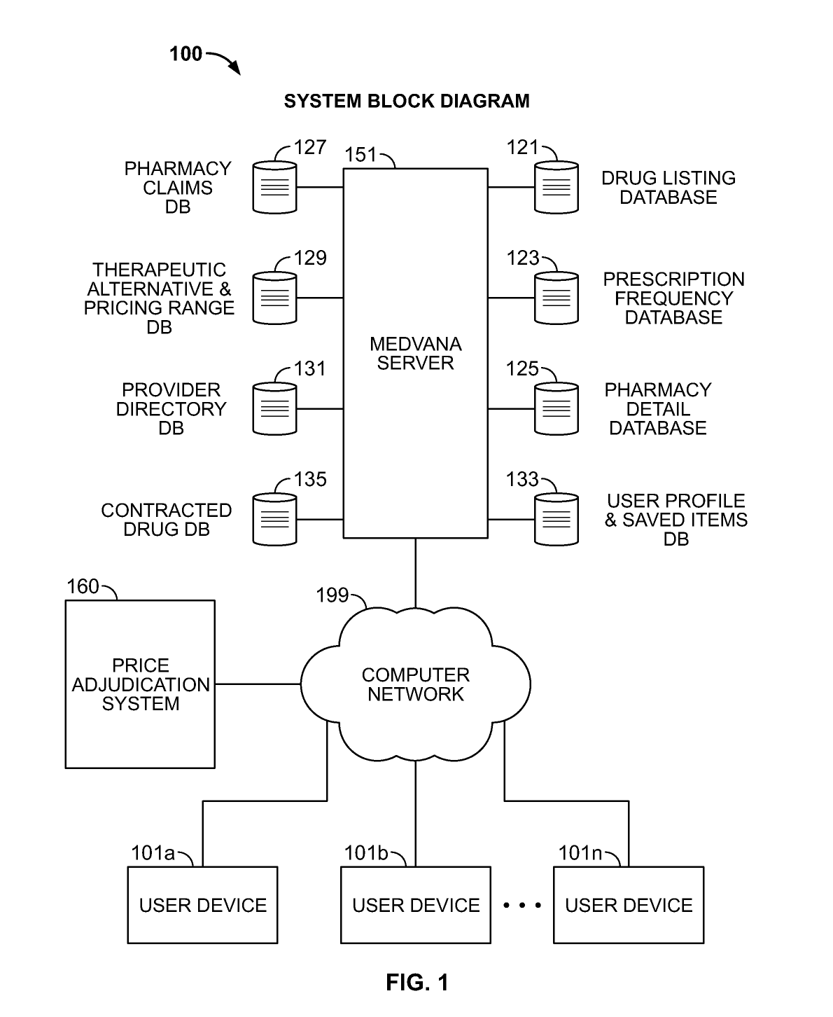

FIG. 1 is an example of a system 100 that compares healthcare costs, finds providers, and manages prescribed treatments. The healthcare management system 100 routes user input from user devices to a server and delivers medical treatment information and pricing from the Medvana server 151 to user devices 101a, 101b, and 101n via the computer network 199, such as the Internet. Price adjudication system 160 is accessed by the Medvana server 151 to provide real-time pricing of specific drugs, medical supplies, and/or medical treatments. Price adjudication system 160 includes negotiated pricing of drugs, services, and/or treatments at specific pharmacies and providers where user can take advantage of discounts offered by the pharmacies and providers to users of the system 100. Price adjudication system 160 can include multiple databases and computing devices that provide the negotiated pricing of the drugs, services, and/or treatments to the Medvana server 151 for further use in the system, device, and method of the claimed invention. The price adjudication system 160 can be physically separate from the Medvana server 151, such as in the case where third parties provide the negotiated pricing, or the price adjudication system 160 can be integrated within the Medvana server 151.

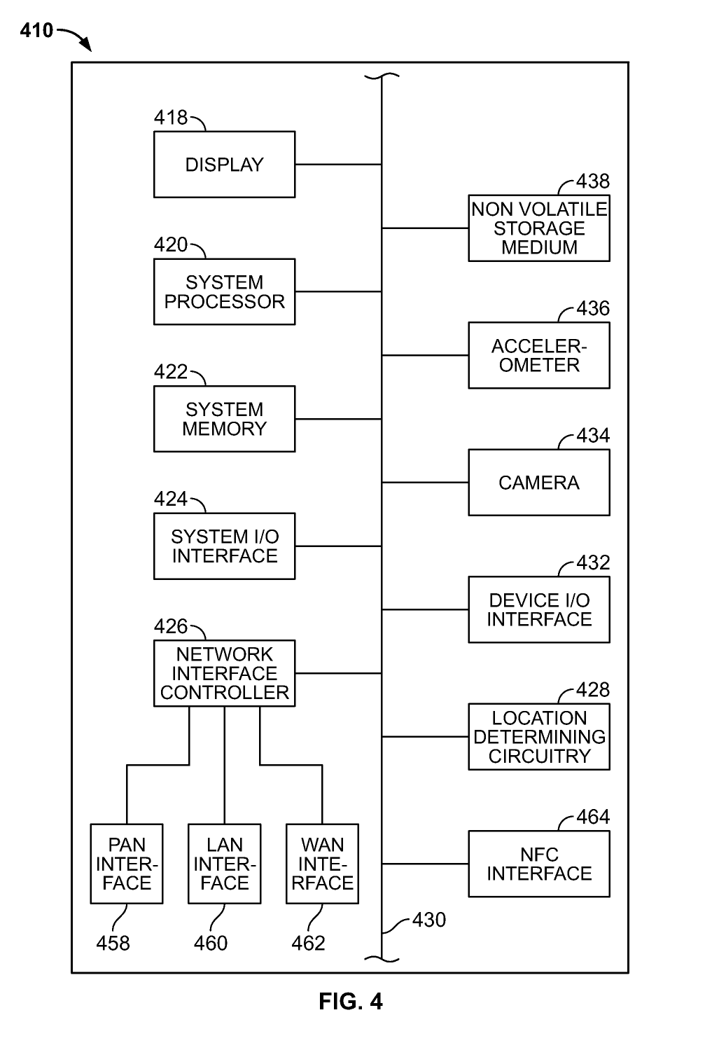

Multiple servers can be used in the system 100 and likewise, multiple user devices cans also be used in the system 100, such as when a Medvana server 151 is sending medical treatment information to multiple users on multiple user devices. For clarity and brevity, a single server 151 and three user devices 101a, 101b, 101n are shown in FIG. 1. An example of the Medvana server and/or a user device is shown in FIG. 4 and described in detail below.

In addition, Medvana server 151 accesses a number of databases to retrieve data, process requests from user devices 101, and otherwise provide healthcare provider cost information, including prescription drug cost information for pharmacies. The Medvana server 151 accesses Drug Listing Database 121, Prescription Frequency Database 123, Pharmacy Detail Database 125, Pharmacy Claims Database 127, Therapeutic Alternative and Pricing Range Database 129, Provider Directory Database 131, User Profile and Saved Items Database 133, and Contracted Drug Database 135 to perform methods of the claimed invention.

The drug listing database 121 is configured to determine the right family of drugs given a casual user's description. There are several forms of a given drug based on the chemical composition, dosage, route of administration, form of the medicine, and package size of the product by the manufacturer. The drug listing database 121 uses a taxonomy of drug names to lead the user to right input selection.

The prescription frequency database 123 is configured to determine which packages of a given drug users most frequently fill at pharmacies. The prescription frequency database 123 uses millions of records of recent transactions at pharmacies nationwide to determine the top most commonly prescribed packages. This information is used to prioritize the search results and present the user with alternative package (type, dose, quantity) options.

The pharmacy detail database 125 is configured to search for local pharmacies using the GPS or other location determining circuitry of the smartphone, browser or zip code entered by user. The pharmacy detail database 125 is also configured to determine the name, logo, address, phone number, store hours and other relevant details of over 60,000 pharmacies. The pharmacy detail database 125 also includes the longitude and latitude of each pharmacy to enable GPS or location search. The pharmacy detail database 125 includes affiliation codes to identify the ownership or affiliation of an individual pharmacy or store to a chain or larger corporate entity (e.g., CVS, Walgreens).

The pharmacy claims database 127 is configured to determine the average price for a given drug (with all its associated dose, quantity and package size details) at a given pharmacy. Millions of recent transactions from pharmacies nationwide are aggregated and averaged using a cascading algorithm that averages the most recent retail price at a specific provider, considering the owner and chain affiliations of a group and the state that provider is located, to determine or approximate what price a user would be charged at a pharmacy for a given drug if they did not have the benefit of any discounts. This price is often referred to as the “Usual and Customary price” or Retail Price.

The therapeutic alternative and pricing range database 129 is configured to determine the family of chemically and therapeutically related drugs that a user views as a substitute to the drug the user searched for. While the final determination of clinically applicability for any specific user rests with the prescribing physician, this therapeutic alternative and pricing range database 129 helps list the possible options available to users so they might prompt or remind their physicians of lower cost options that could effectively meet the user's treatment goals.

The provider directory database 131 is configured to apply a structured classification system based on the role and medical specialty to classify medical providers and their facilities. Users are able to search for a specific provider by name, type or location proximity and obtain details such as phone numbers, addresses and other relevant particulars.

The user profile and saved items database 133 is configured to store a user's search preferences, specific drugs, pharmacies, medical providers and other relevant details that the user chooses to store or save on the computing device, smartphone, website, and the like.

The contracted drug database 135 is configured to translate a user's searched drug type and details with the drugs that have been contracted for with pharmacies. For example, there are over 20 different drug listings for Simvastatin/Zocor, each with their own unique industry codes (National Drug Code or NDC). This contracted drug database 135 identifies the specific industry codes that conform to the contracted rates with pharmacies so users can get an accurate price despite the proliferation of codes.

Generally, Medvana server 151 and user devices 101 can include any computing device capable of connecting to another computing device to send and receive information, including web-based information. In one example, wireless user devices 101 communicate with the Medvana server 151 via a computer network 199. These user devices can also include devices that typically connect using a wired and/or a wireless communications medium, such as personal computers, desktop computers, laptop computers, notebook computers, tablet PCs, Internet tablets, personal digital assistants, smart phones, cellular telephones, carputers, mobile phones, smart phones, personal digital assistants, and the like. These mobile and portable computing devices can include wireless access to private networks and to public networks, such as the Internet. Additionally, these devices can include synchronization features, multimedia functionality, database functionality, and other computer features in a variety of program modules.

Program modules include routines, programs, objects, components, data structures, and the like that perform particular tasks or implement particular abstract data types. The system, device, and method of the claimed invention can be practiced with other computer system configurations, including hand-held devices, multiprocessor systems, microprocessor-based or programmable consumer electronics, networked PCs, minicomputers, mainframe computers, and the like.

In these examples, the user devices can run native mobile applications, self-contained program modules, as well as web browsers that can provide an interface to make requests to different web server-based applications via the system 100. A series of self-contained and web-based applications can run on the Medvana server 151 and on the user devices 101 that facilitate the transmission of data. The Medvana server 151 and the user devices 101 can be further configured to engage in a secure communication with other devices and/or each other using mechanisms such as Application Programming Interfaces (APIs), Secure Sockets Layer (SSL), Internet Protocol Security (IPSec), Tunnel Layer Security (TLS), and the like. The examples shown and described in this detailed description use English language icons, buttons, keys, and the like as part of a user interface. However, other languages, including Spanish, French, Italian, and others can also be used to display, enter, search, and fully utilize the features and benefits of the claimed invention. A user can select a language preference upon installation of the medical savings app. Likewise, the system 100 can select a language preference for a particular user device 101 based upon the location of the device, for example.

Server and User Device Components

Each of the Medvana server 151 and user devices 101 can include a central processing unit (CPU), controller or processor, a memory, and an interface system which are coupled together by a bus or other link, although other numbers and types of each of the components and other configurations and locations for the components can be used.

As shown further in FIG. 4, the medical savings management system 100 of the claimed invention, including the Medvana server 151 and user devices 101 are shown as an example “computing device” 410. Computing device 410 includes system processor(s) 420, system memory 422, system I/O interface(s) 424, network interface controller 426, location determining circuitry 428, and display 418, which are coupled together by a bus 430 or other types of links. Additionally, the computing device 410 also can include nonvolatile storage medium 438, device I/O interface 432, camera 434, and accelerometer 436. The medical savings management computing devices 410 can include other components and elements in other configurations. In this example, the medical savings management computing device 410 is implemented as a standalone handheld electronic device.

Computing device 410 may be configured for identifying, locating, and comparing prescription drug among pharmacies and healthcare costs among healthcare providers. As discussed below with reference to FIGS. 1-4, the computing device 410 may be, among other things, a handheld device, a computer, or a media player adapted to obtain, store, or use prescription drug information and pharmacy information, using methods described in greater detail below. The computing device 410 can also be a manned or unmanned kiosk or electronic cash register and the like to sell or otherwise dispense prescription drugs to patients. The computing device 410 can be an iPhone®, iPod®, iMac®, MacBook., available from Apple Inc., as well as any number of devices available from Nokia, RIM, Motorola, HTC, Samsung, LG, HP, or similar devices such as by any manufacturer. In other example embodiments of the claimed invention, computing device 410 can include more or fewer elements than those shown in FIG. 4.

The computing device 410 may include at least one system processor 420. For example, the system processor 420 may include one or more microprocessors, and the microprocessors may be “general purpose” microprocessors, a combination of general and special purpose microprocessors, or application specific integrated circuits (ASICS). Additionally or alternatively, the system processor 420 can include one or more reduced instruction set (RISC) processors, video processors, or related chip sets. The system processor 420 can additionally or alternatively include programmable logic devices (PLDs), field programmable logic devices (FPLDs), field programmable gate arrays (FPGAs), and the like, programmed or configured according to the teachings as described and illustrated with respect to FIGS. 1-4. The system processor 420 can provide processing capability to execute an operating system, run various applications, execute machine readable and executable instructions stored in system memory 422 and/or provide processing for one or more of the techniques described in this disclosure. Some example applications that can run on the computing device 410 include a music player, a video player, a picture displayer, a calendar, an address book, an email client, a telephone dialer, and the like. In addition, software for managing, identifying, locating, and comparing prescription drugs among pharmacies can be included on the computing device 410, as described below.

A system memory 422 is coupled and is in communication with the system processor 420 via bus 430. The system memory 422 can store data and executable code. The system memory 422 can represent volatile memory such as RAM, but can also include nonvolatile memory, such as read-only memory (ROM) or Flash memory. System memory 422 can also include removable and non-removable media implemented in any method or technology for storage of information, such as computer readable/machine-executable instructions, data structures, program modules, or other data, which can be obtained and/or executed by one or more processors, such as system processor 420, to perform actions, including implementing an operating system for controlling the general operation of medical savings management computing device 410 to send and receive medical savings management documents in accordance with the processes described above in connection with FIGS. 1-4, for example. In buffering or caching data related to operations of the system processor 420, the system memory 422 can store data associated with open applications running on the computing device 410.

The computing device 410 can also include nonvolatile storage medium 438. The nonvolatile storage medium 438 can represent any suitable nonvolatile storage medium, such as a hard disk drive or nonvolatile memory, such as flash memory. Other examples of nonvolatile storage medium 438 include RAM, BIOS, ROM, EEPROM, flash/firmware memory, CD-ROM, digital versatile disks (DVD) or other optical storage, magnetic cassettes, magnetic tape, magnetic disk storage or other magnetic storage devices, or any other nonvolatile storage medium that can be used to store the desired information. The nonvolatile storage medium 438 is well-suited to long-term storage and can store data files such as media (e.g., music files, video files, pictures, and the like), software (e.g., for implementing functions on the computing device 410), preference information (e.g., media playback preferences, desktop background image, ringtones, etc.), transaction information (e.g., credit card data, records of transactions, etc.), wireless connection information (e.g., wireless network names and/or passwords, cellular network connections, etc.), subscription information (e.g., a record of podcasts, television shows, or other media to which a user subscribes), as well as personal information (e.g., contacts, calendars, email, etc.). Additionally, prescription drug and pharmacy data may be saved in the nonvolatile storage medium 438, as discussed further below.

In some example embodiments, a display 418 of the computing device 410 can display images and/or data. The display 418 can be any suitable display, such as a liquid crystal display (LCD), a plasma display, an electronic paper display (e.g., E Ink), a light emitting diode (LED) display, an organic light emitting diode (OLED) display, a cathode ray tube (CRT) display, or an analog or digital television. In some example embodiments, the display 418 can include touch screen or multi-touch screen technology through which a user can interface with the computing device 410.

The computing device 410 can also have a system I/O interface 424. The system I/O interface 424 can include, for example, indicator lights, user inputs, and/or a graphical user interface (GUI) on the display 418. In practice, the system I/O interface 424 can operate via the system processor 420, using memory from the system memory 422 and long-term storage in the nonvolatile storage medium 438. In an embodiment without the display 418, indicator lights, sound devices, buttons, and other numerous input/output (I/O) devices can allow a user to interface with the computing device 410. In an embodiment with a GUI, the system I/O interface 424 can provide interaction with interface elements on the display 418 via certain user input structures, user input peripherals such as a keyboard or mouse, or a touch sensitive implementation of the display 418. System I/O interface 424 enables the medical savings management computing devices 410 to communicate with the outside environment for accepting user data input and to provide user output.

In operation of the computing device 410, one or more applications can be open and accessible to a user via the system I/O interface 424 and/or displayed on the display 418 of the computing device 410. The applications can run on the system processor 420 in conjunction with the system memory 422, the nonvolatile storage medium 438, the display 418, and the system I/O interface 424. Various data can be associated with each open application. As discussed in greater detail below, instructions stored in the system memory 422, the nonvolatile storage medium 438, or the system processor 420 of the computing device 410 can obtain, store, and use prescription drug and pharmacy documents. Users can employ the computing device 410 to manage prescription drug costs electronically. The instructions for carrying out such processes can represent a standalone application, a function of the operating system of the computing device 410, or a function of the hardware of the system processor 420, the system memory 422, the nonvolatile storage medium 438, or other hardware of the computing device 410.

In some embodiments of the claimed invention, the computing device 410 can include location determining circuitry 428. The location determining circuitry 428 can represent global positioning system (GPS) circuitry, but can also represent one or more algorithms and databases, stored in the nonvolatile storage medium 438 or system memory 422 and executed by the system processor 420, that can be used to infer location based on various observed factors. For example, the location determining circuitry 428 can include an algorithm and database that approximates geographic location based on the detection of local wireless networks (e.g., 802.11x, otherwise known as Wi-Fi) or nearby cellular phone towers. As discussed below, the computing device 410 can employ the location determining circuitry 428 as a factor for carrying out certain prescription drug and pharmacy identification and cost determination processes in accordance with the application of the claimed invention. For example, the location determining circuitry 428 can be used by the computing device 410 to determine a user's location during an event. The location during the event can then affect and/or determine the information displayed on the computing device 410. The location information enables the medical savings management application to display personalized data or to display data in response to a user's location.

The computing device 410 can also include a device input/output (I/O) interface 432 for a wired interconnection between one computing device 410 and another computing device 410. The wired device I/O interface 432 can be, for example, a universal serial bus (USB) port or an IEEE 1394 port (e.g., FireWire®, available from Apple Inc.), but can also represent a proprietary connection. Additionally, the wired device I/O interface 432 can permit a connection to peripheral user interface devices, such as a keyboard or a mouse.

Network interface controllers 426 can provide physical access to networking media and provides a low-level addressing system, which enables the medical savings computing devices 410 to engage in TCP/IP communications and other communications with other devices over the computer network 199 (shown in FIG. 1). One or more network interface controllers 426 can provide additional connectivity for the computing device 410. The network interface controllers 426 can include, for example, one or more network interface cards (NIC), transceivers, transceiving devices, or network controllers that transmit and receive network data packets over one or more networks. In some embodiments, the network interface controller 426 can include a personal area network (PAN) interface 458. The PAN interface 458 may provide capabilities to network with, for example, a Bluetooth® network, an IEEE 802.15.4 (e.g., ZigBee) network, or an ultra wideband (UWB) network. The networks accessed by the PAN interface 458 can, but do not necessarily, represent low power, low bandwidth, or close range wireless connections. The PAN interface 458 can permit one computing device 410 to connect to another local computing device 410 via an ad-hoc or peer-to-peer connection. However, the connection can be disrupted if the separation between the two electronic devices 410 exceeds the range of the PAN interface 458.

The network interface controller 426 can also include a local area network (LAN) interface 460. The LAN interface 460 can be, for example, an interface to a wired Ethernet-based network or an interface to a wireless LAN, such as a Wi-Fi network. The range of the LAN interface 460 can generally exceed the range available using the PAN interface 458. Additionally, in many cases, a connection between two electronic devices 410 via the LAN interface 460 can involve communication through a network router or other intermediary device.

Additionally, for some example embodiments of the computing device 410, the network interface controllers 426 can include the capability to connect directly to a wide area network (WAN) via a WAN interface 462. The WAN interface 462 can permit a connection to a cellular data network, such as the Enhanced Data rates for GSM Evolution (EDGE) network, a 3G network, or another cellular network. When connected via the WAN interface 462, the computing device 410 can remain connected to the Internet and, in some example embodiments, to another computing device 410, despite changes in location that might otherwise disrupt connectivity via the PAN interface 458 or the LAN interface 460. As will be discussed below, the wired device I/O interface 432 and the network interface controllers 426 can represent high-bandwidth communication channels for transferring user data using the simplified data transfer techniques discussed herein.

Some example embodiments of the computing device 410 can also include a near field communication (NFC) interface 464. The NFC interface 464 can allow for extremely close range communication at relatively low data rates (e.g., 424 kb/s), and can comply with such standards as ISO/IEC 18092, ECMA-340, ISO/IEC 21481, ECMA-352, ISO 14443, and/or ISO 15693. The NFC interface 464 can have a range of approximately 2-4 cm. The close range communication with the NFC interface 464 can take place via magnetic field induction, allowing the NFC interface 464 to communicate with other NFC interfaces 464 or to retrieve information from tags having radio frequency identification (RFID) circuitry and with other NFC-equipped computing devices 410. The NFC interface 464 can enable initiation and/or facilitation of data transfer of documents and other data from one computing device 410 to another computing device 410, including prescription drug documents, pharmacy documents, and prescription drug cost and pricing documents to and from user devices 101, Medvana server 151 and price adjudication system 160 as shown in FIG. 1.

The computing device 410 can also include a camera 434. With the camera 434, the computing device 410 can obtain digital images and/or videos. For example, prescription drug information and documents can be obtained using camera 434. In combination with optical character recognition (OCR) software, barcode-reading software, or QR-code-reading software running on the computing device 410, the camera 434 can be used to input data from printed materials having text or barcode information into an application/method of the claimed invention.

In addition, in some example embodiments of the computing device 410, one or more accelerometers 436 can be included that sense the movement and/or orientation of the computing device 410. The accelerometers 436 can provide input or feedback regarding the position of the computing device 410 to the medical savings application (and others) running on the system processor 420. The accelerometer information enables the applications to display personalized data or to display data in an innovative manner in response to a user's movement. The accelerometers 436 can include a 3-axis accelerometer from InvenSense, ST Microelectronics, or Analog Devices, for example.

Bus 430 includes at least one internal device component communication bus, link, bridge and supporting components, such as bus controllers and/or arbiters. These devices enable the various components of the medical savings management computing device 410, such as the display 418, system processor 420, system memory 422, system I/O interface 424, network interface controller 426, and location determining circuitry 428 (as well as wired device I/O interface 432, camera 434, accelerometer 436, and nonvolatile storage medium 438) to communicate, although the bus 430 can enable one or more components of the medical savings management computing device 410 to communicate with components in other devices as well. By way of example only, example buses include HyperTransport, PCI, PCI Express, InfiniBand, USB, Firewire, Serial ATA (SATA), SCSI, IDE and AGP buses, although other types and numbers of buses can be used, and the particular types and arrangement of buses will depend on the particular configuration of medical savings management computing device 410.

In addition to touch-sensitive input capabilities of the display 418, user input switches can augment and/or replace the touch-sensitive input capability of the display 418 for interaction with the system I/O interface 424. The switches can include buttons, switches, a control pad, keys, knobs, a scroll wheel, or any other suitable input structures. The user input switches can work in conjunction with the display 418 to control functions of the computing device 410. The user input switches can include an on/off switch, a navigation button for navigating the system I/O interface 424 to a home screen, buttons for controlling volume, buttons for navigating up and down display 418 screen, a mute switch, a lock slide, and the like.

The computing device 410 can also include audio input and/or output buttons. The audio buttons can include a microphone(s) that receives a user's voice data and/or a speaker(s) that output audio data from the computing device 410. The output audio can include ring tones, songs, video sound tracks, telephone call audio data, recorded audio input data stored on the computing device 410 or elsewhere, and the like. An audio input connector can also be included on the computing device 410 to allow external audio inputs (e.g., from microphones and other audio output devices) and to allow external audio outputs (e.g., to headphones, ear buds, speakers, and other audio input devices).

While each of the computing devices and servers can include the above constituent components coupled together by a bus 430, two or more computing devices and/or servers can be substituted for any one of the user devices or server(s) in the system 100. Likewise, other numbers and types of each of the components and other configurations and locations for the components can be used. Accordingly, principles and advantages of distributed processing, such as redundancy, replication, and the like, also can be implemented as desired to increase the robustness and performance of the user devices and server(s) of the system 100. The system 100 can also be implemented on a computer system or systems that extend across any network environment using any suitable interface mechanisms and communications technologies including, for example telecommunications in any suitable form (e.g., voice, modem, and the like), Public Switched Telephone Network (PSTNs), Packet Data Networks (PDNs), the Internet, intranets, a combination thereof, and the like.

The processors in the computing devices can execute a program of stored instructions for one or more aspects of the methods and systems as described in this disclosure, although the processor could execute other types of programmed instructions. The memory can store these programmed instructions for one or more aspects of the methods and systems as described in this disclosure, although some or all of the programmed instructions could be stored and/or executed elsewhere.

The operation of example processes to provide a system and method of delivering medical savings management documents shown in FIGS. 1-4 can be run on the medical savings management system 100. The flow diagrams of FIGS. 1-4 are representative of example machine readable instructions executed by the computing device(s) and/or server(s) for implementing the process of delivering medical savings management documents and files. The steps described above are example machine readable instructions for implementing a method in accordance with the examples described in this disclosure. In one example, the machine readable instructions include an algorithm for execution by: (a) a processor, (b) a controller, and/or (c) one or more other suitable processing device(s). The algorithm can be instantiated in software stored on tangible media such as, for example, the system memory and/or nonvolatile storage medium, but persons of ordinary skill in the art will readily appreciate that the entire algorithm and/or parts thereof could alternatively be executed by a device other than a processor and/or embodied in firmware or in dedicated hardware including application specific integrated circuits (ASIC), programmable logic devices (PLD), field programmable logic devices (FPLD), field programmable gate arrays (FPGA), and the like). For example, any or all of the components of the medical savings management system could be implemented by software, hardware, and/or firmware.

Application Architecture

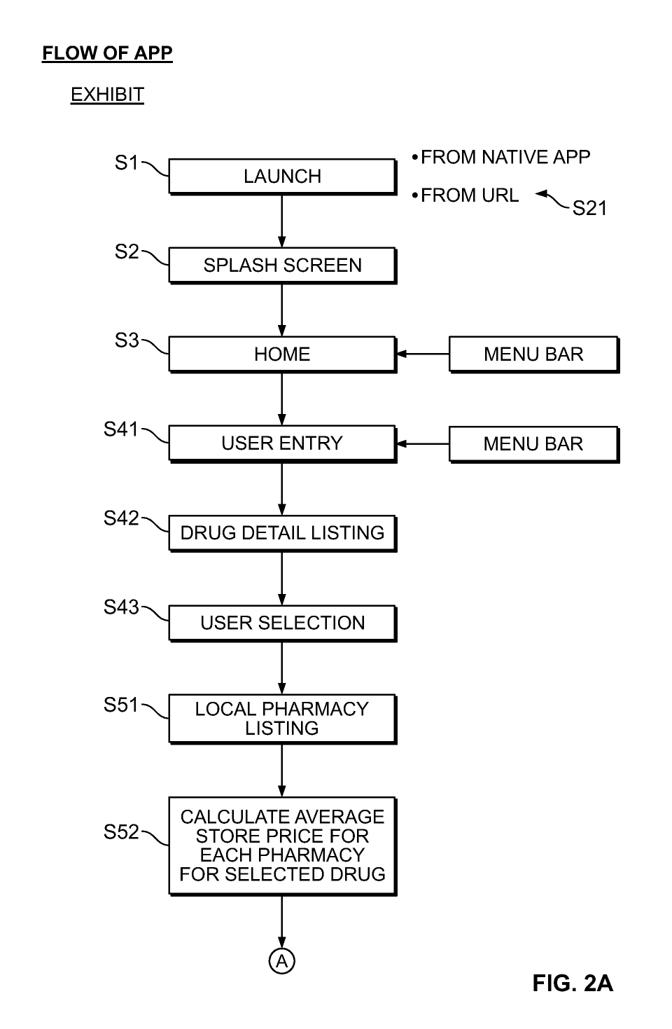

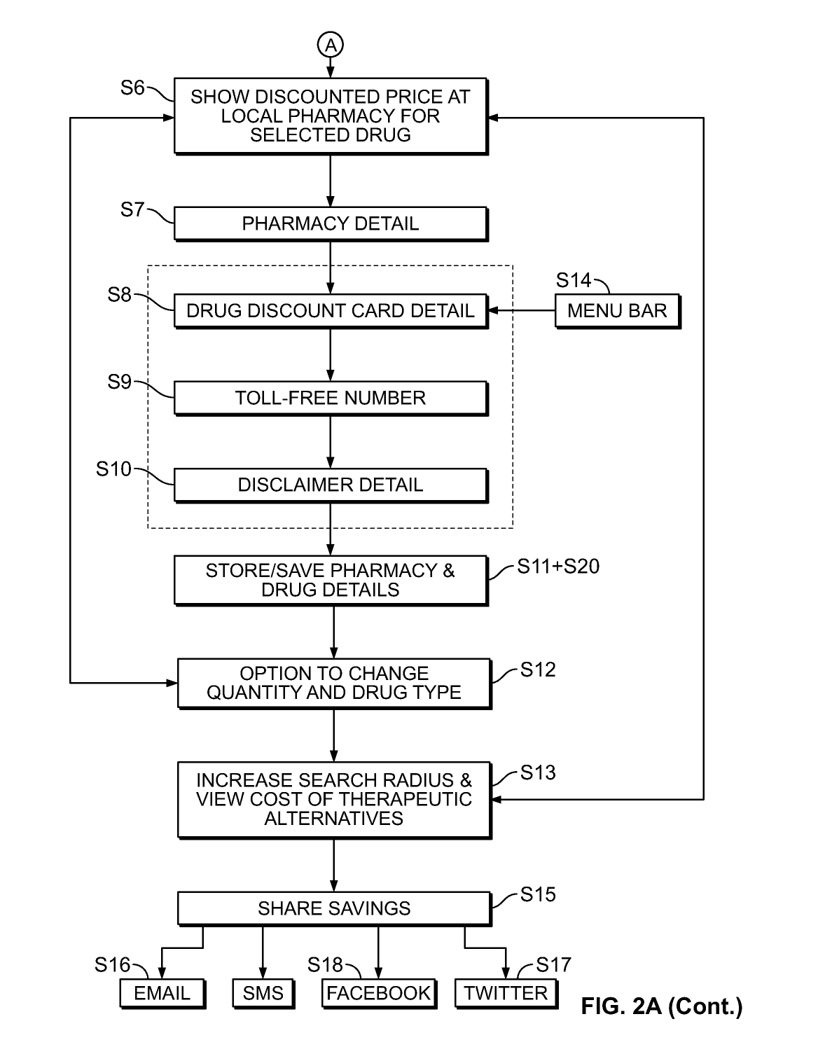

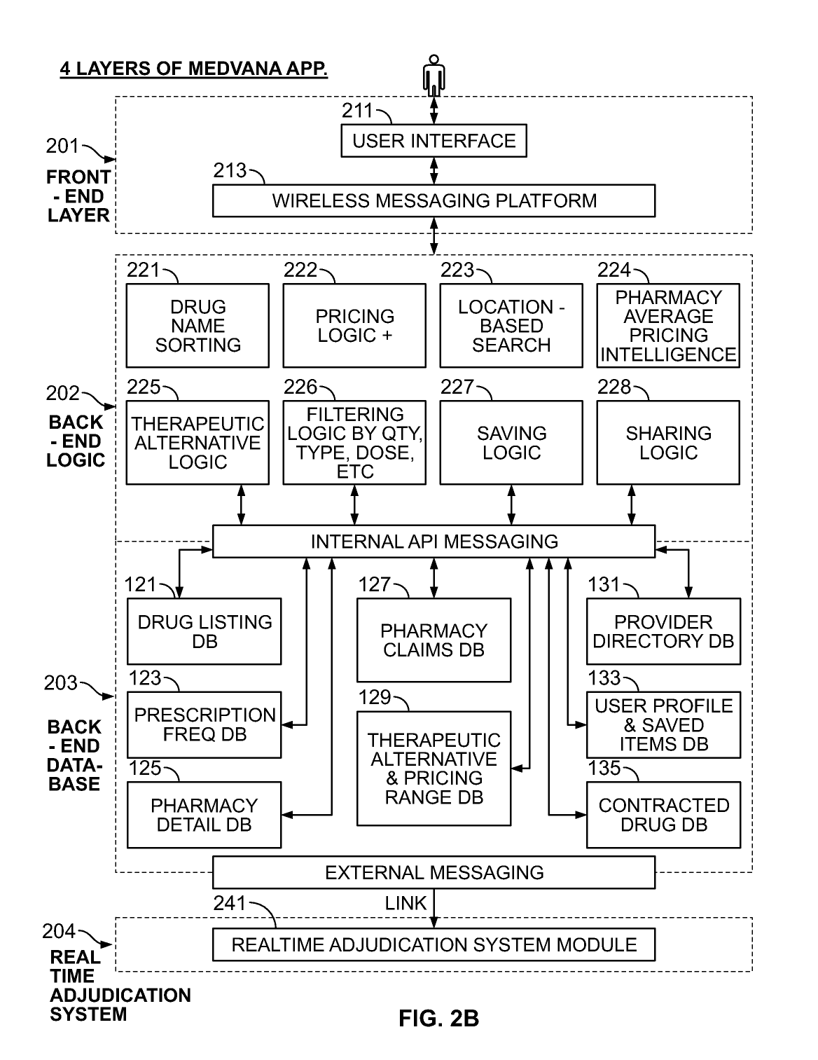

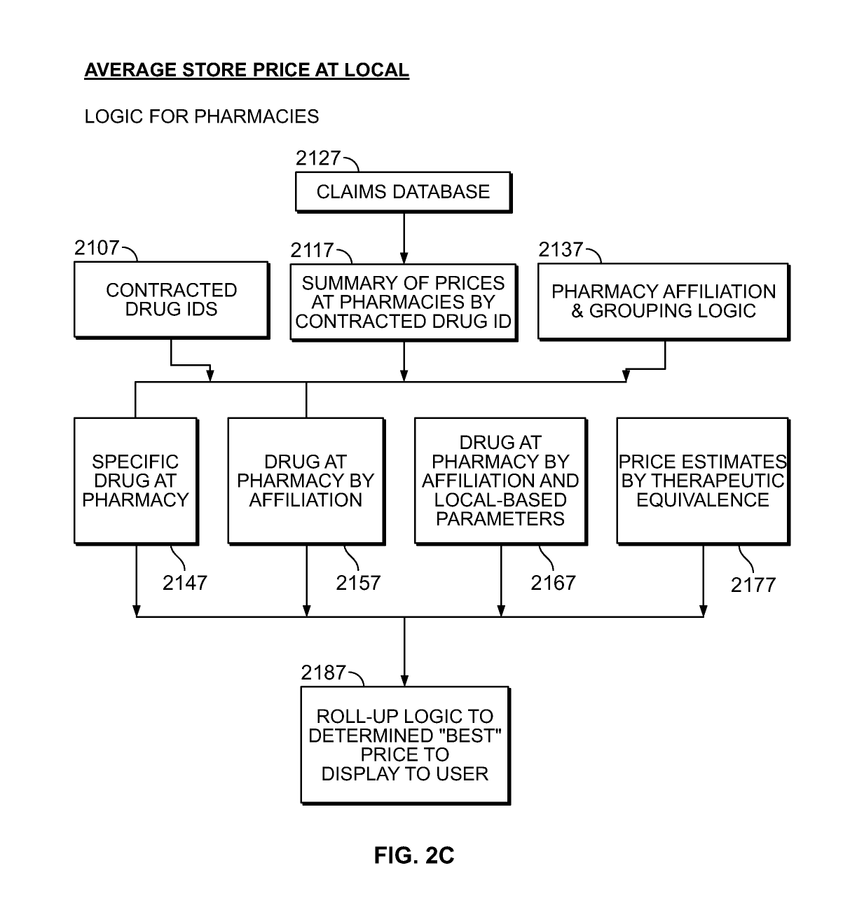

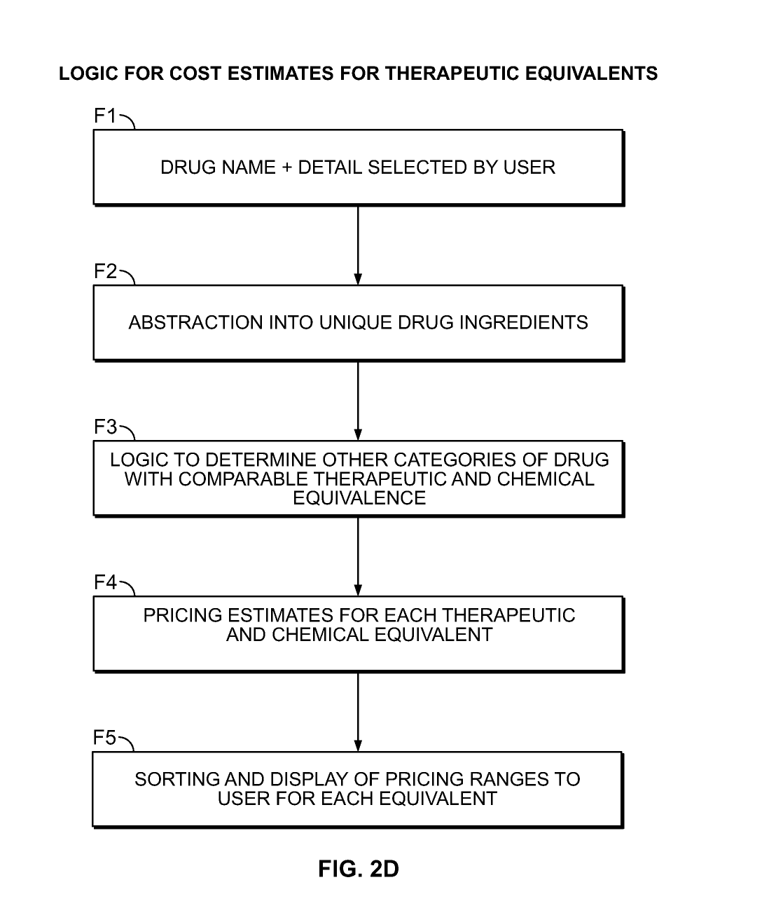

The system and method of the claimed invention is configured in a four-layer client-server architecture as shown in FIG. 2B. In the medical savings application of the claimed invention, the presentation tier, application processing, and data management functions and modules are logically separated. An additional real time link to an adjudication system 290 is also logically separated from the other modules. The data management functions can be performed within the Medvana server 151 and its respective databases 121, 123, 125, 127, 129, 131, 133, 135, or via application programming interfaces (APIs), web services, and/or other remote connectivity protocols to other Medvana server systems and/or to 3^{rd} party systems that can determine, aggregate, and present the results of the medical savings application to the Medvana server 151 or to the user device 101 directly. For example, logic modules, logical computations, and databases can be linked from the Medvana server 151 via APIs provided by a third party.

The presentation tier is shown in FIG. 2B as the front end layer 201. Front end layer 201 provides a user interface 211 and wireless messaging platform 213. Front end layer 201 includes distributed logic capabilities to connect to the Medvana server 151 to send and receive requests and translates the tasks performed by the other layers and the results generated by the other layers into documents, GUI output, and other formatted information for consumption by a user. The documents, GUI output, and other formatted information are accessed directly by the users. Wireless messaging platform 213 includes email, text messaging, and other wireless messaging capabilities to transmit and receive data structures, logic, input documents, output documents, and the like.

The logic tier is shown in FIG. 2B as back-end logic layer 202. Back-end logic layer 202 performs processing in accordance with the systems and methods of the claimed medical savings management application. The back-end logic layer 202 processes commands, performs calculations, and makes logical decisions and evaluations. Back-end logic layer 202 includes drug name sorting module 221, pricing logic module 222, location-based search module 223, pharmacy average pricing intelligence module 224, therapeutic alternative logic module 225, filtering logic module 226, saving module 227, and sharing module 228. Using the various modules, the back-end logic layer 202 also moves data between the other layers and processes data between the other layers. Back-end logic layer 202 includes business objects and rules, data manipulation and transformation capabilities. Communication between the other layers can include internal API messaging, web services, and similar communication techniques to interface with the database layer and handle data inputs and outputs, for example.

The data tier is shown in FIG. 2B as back-end database layer 203. The back-end database layer 203 stores and retrieves information from a number the databases, including Database layer 203 includes Drug Listing Database 121, Prescription Frequency Database 123, Pharmacy Detail Database 125, Pharmacy Claims Database 127, Therapeutic Alternative and Pricing Range Database 129, Provider Directory Database 131, User Profile and Saved Items Database 133, and Contracted Drug Database 135, as described above. Where any of the databases is accessed via an API or via a web service, a single API call can include the function and aggregate results from one or more logical databases. Query, performance, and storage optimization, such as indexing and the like, are performed by the back-end database layer 203. The database information is processed, evaluated, operated upon, and otherwise manipulated by the other layers. New information and new data resulting from these operations can be stored in, added to, and/or deleted from the database layer 203.

The database layer 203 communicates with the price adjudication system 204. The price adjudication system may be accessed in real-time, or via batch processes. The adjudication system may be a “live” system that connects to pharmacies and provider terminals, or be a clone server that mimics the adjudication functions and returns the contracted price for a particular drug or medical therapy at a particular provider. External messaging constructs and similar communication techniques can be used to communicate with price adjudication system 204. Price adjudication system 204 provides a real-time adjudicated price that is not an estimate. The real-time adjudicate price reflects the contracted rate for a particular drug at a particular pharmacy. Other similar programs offer an approximation or “guesstimated price” of what the consumer can expect be charged. In these other programs, when the estimate is lower than the price the pharmacy actually charges the user, it causes confusion and a loss of trust with users. With the system and method of the claimed invention, users have high confidence that the determined and displayed price is the price the pharmacy will charge. Users can push back on the pharmacy with authority if a higher price is presented to them.

As new and different medical services and/or prescription drugs are added, providers of those newly-added medical services and/or prescription drugs are contracted, and the adjudicated price of the drugs/services are added to the databases described above. For example, dental, vision, chiropractic, imaging, and lab discounts are included along with the drug savings to enable users to save on other out-of-pocket healthcare expenses. The Medvana server 151 is also integrated with FSA (flexible savings account) cards, HSA (health savings account) cards, credit cards, debit cards, pre-paid rewards cards, and payroll cards to enable users to make payments, file claims, and, where eligible, receive a second-tier of discounts in the form of tax savings on out-of-pocket healthcare expenses. Integrating the search for low cost providers and contracted discounts with the payment cards provides greater savings, efficient claims processing, and increased convenience for prescription drugs and/or medical services.

Method of Sending and Receiving Medication Therapy Costs

By performing a method of delivering medical savings management files using a system and/or device described above, when a user wishes to receive medical savings management files, such as a listing, comparison, directory, email, message, document, or attachment, a Medvana server 151 can securely deliver the files to the user device. Likewise, one user device 101 can deliver files to other user devices as well. Once connected through a computer network, such as computer network 199 in FIG. 1, the computing device 410 and server 151 can synchronize and/or transfer data, such as prescription drug/medication documents, pharmacy documents, and/or prescription drug/medication cost documents, in accordance with methods discussed in this disclosure.

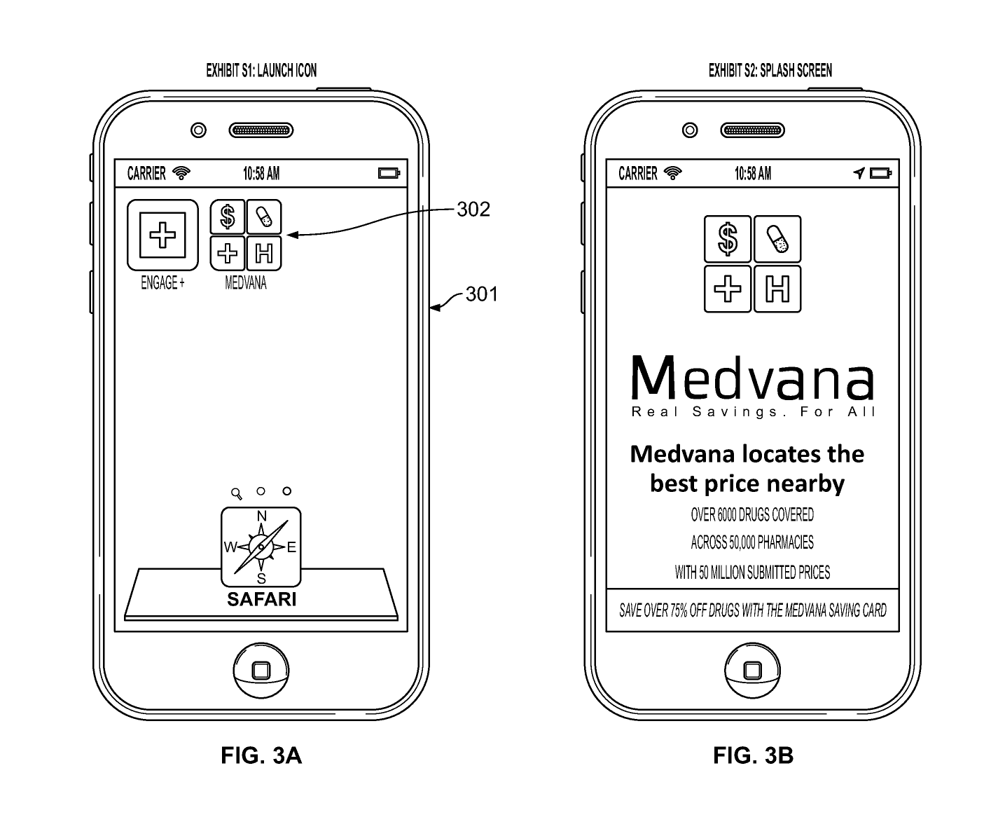

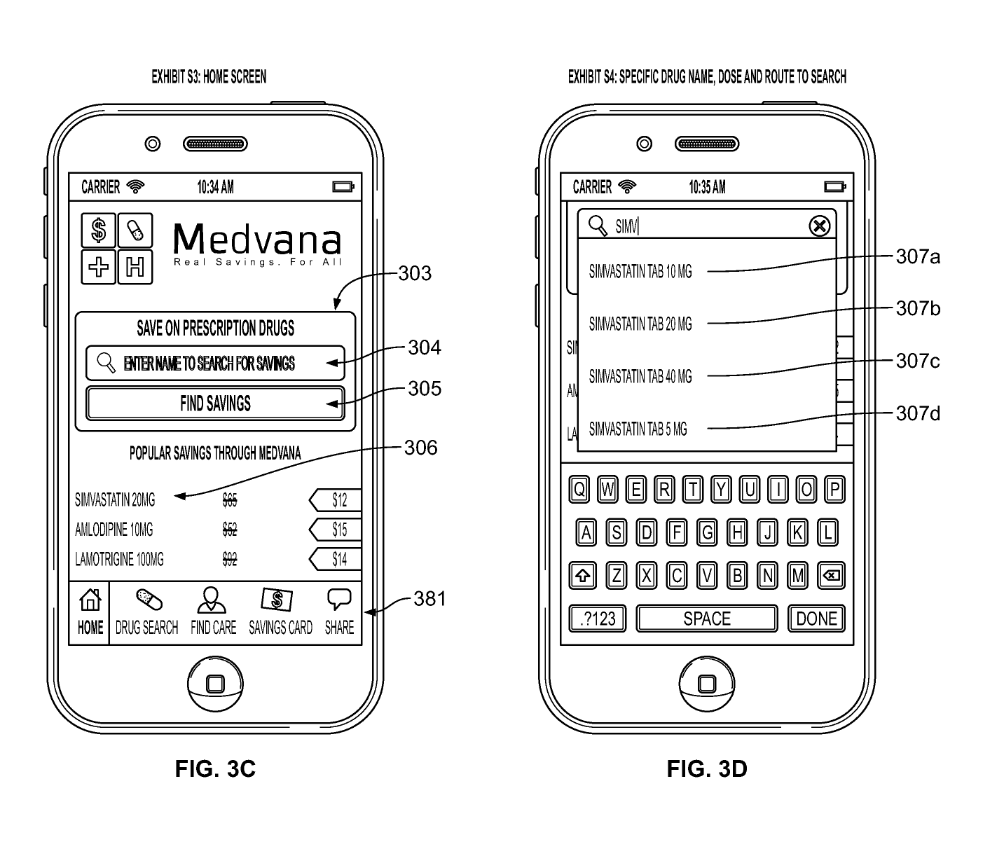

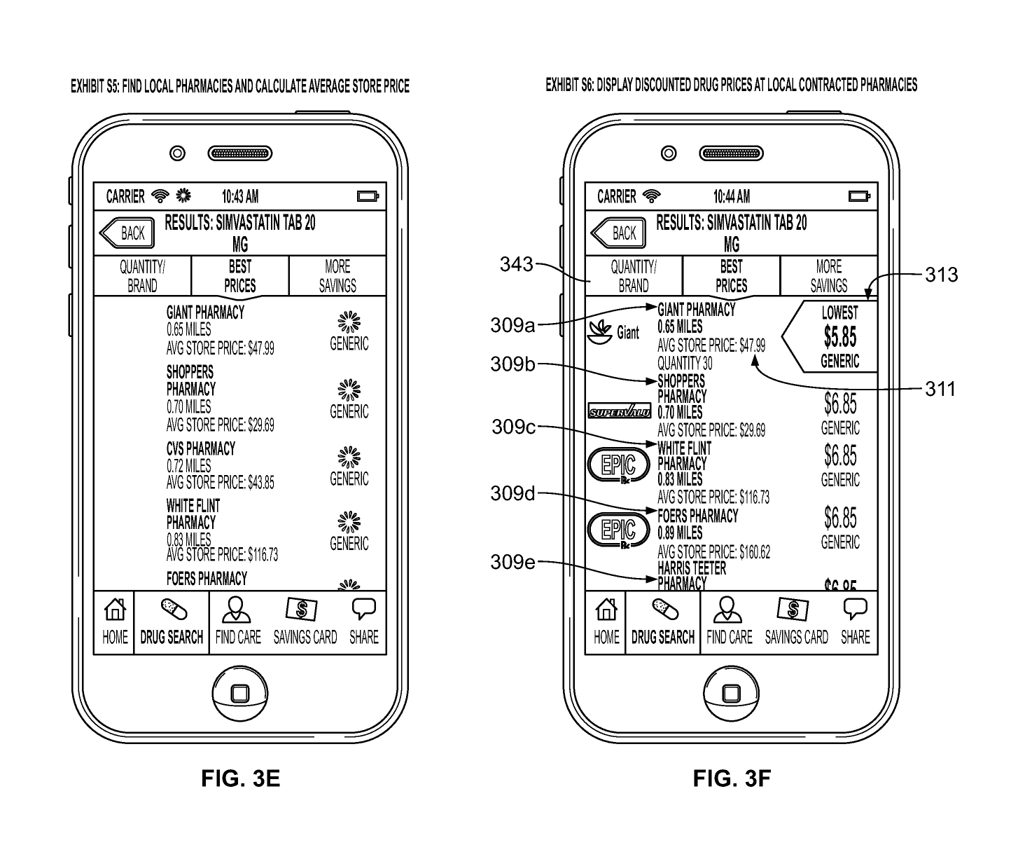

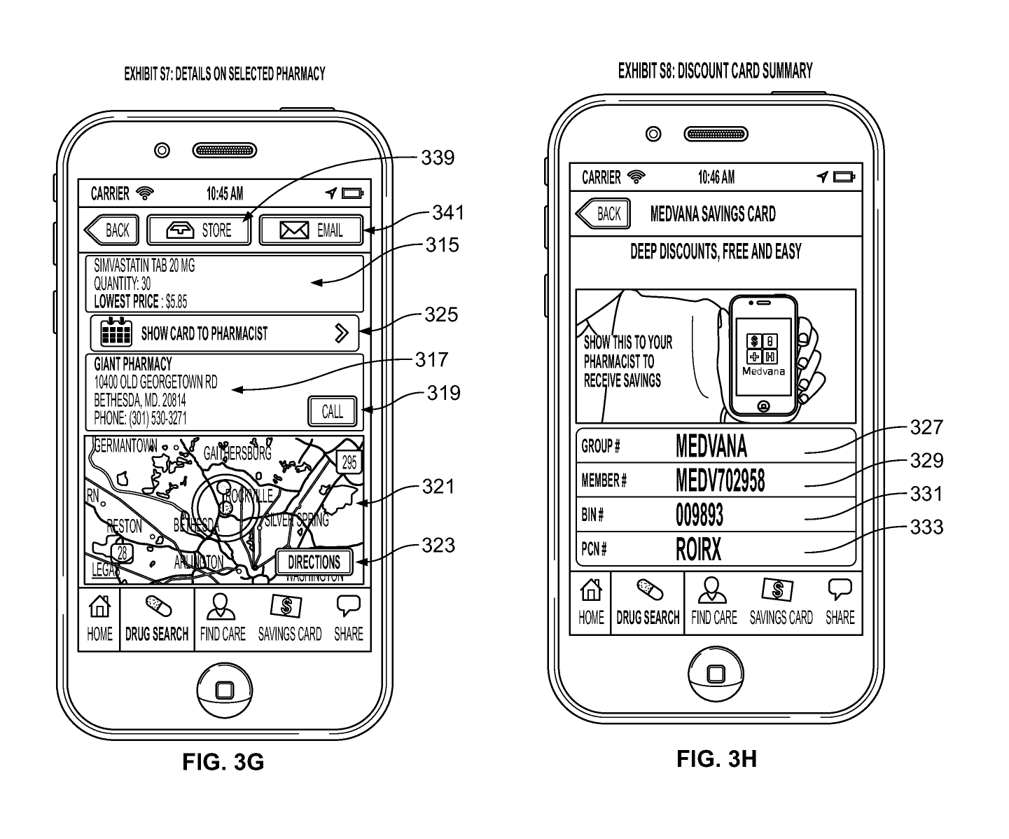

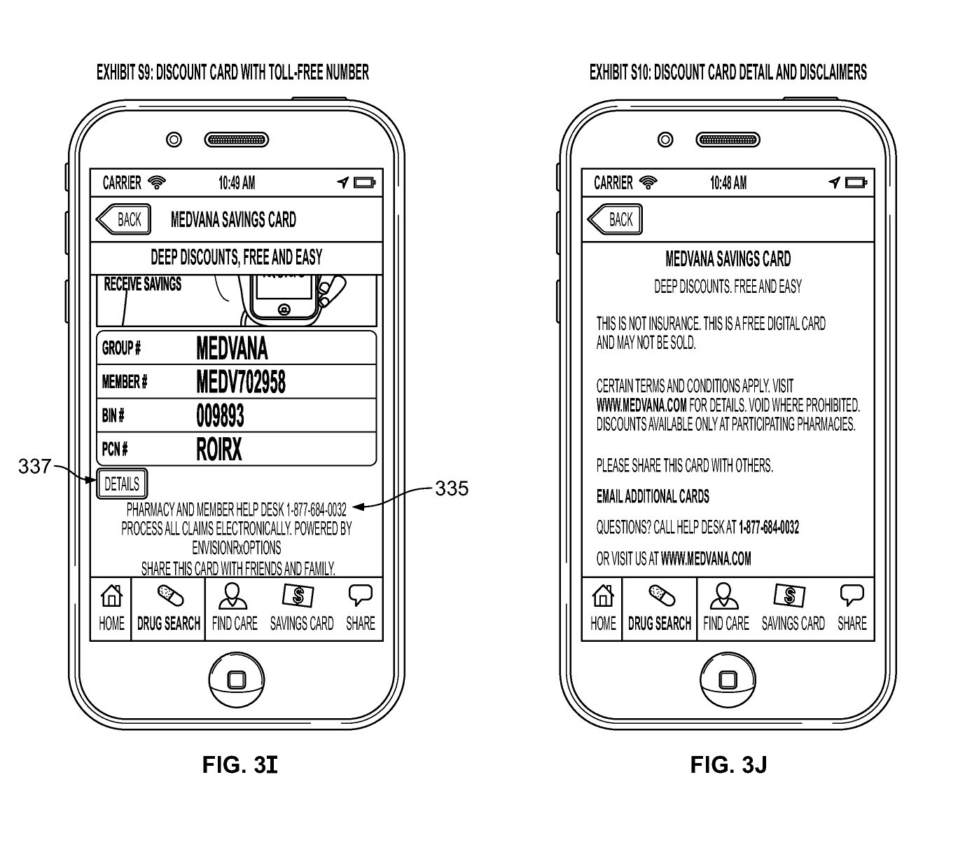

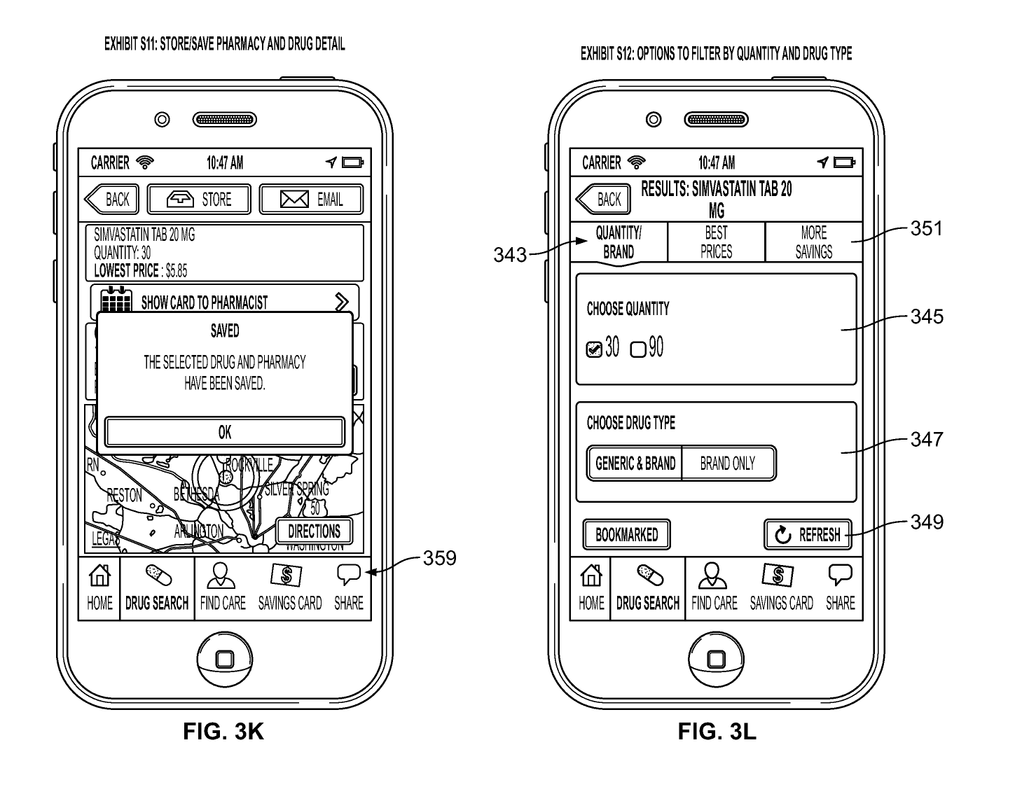

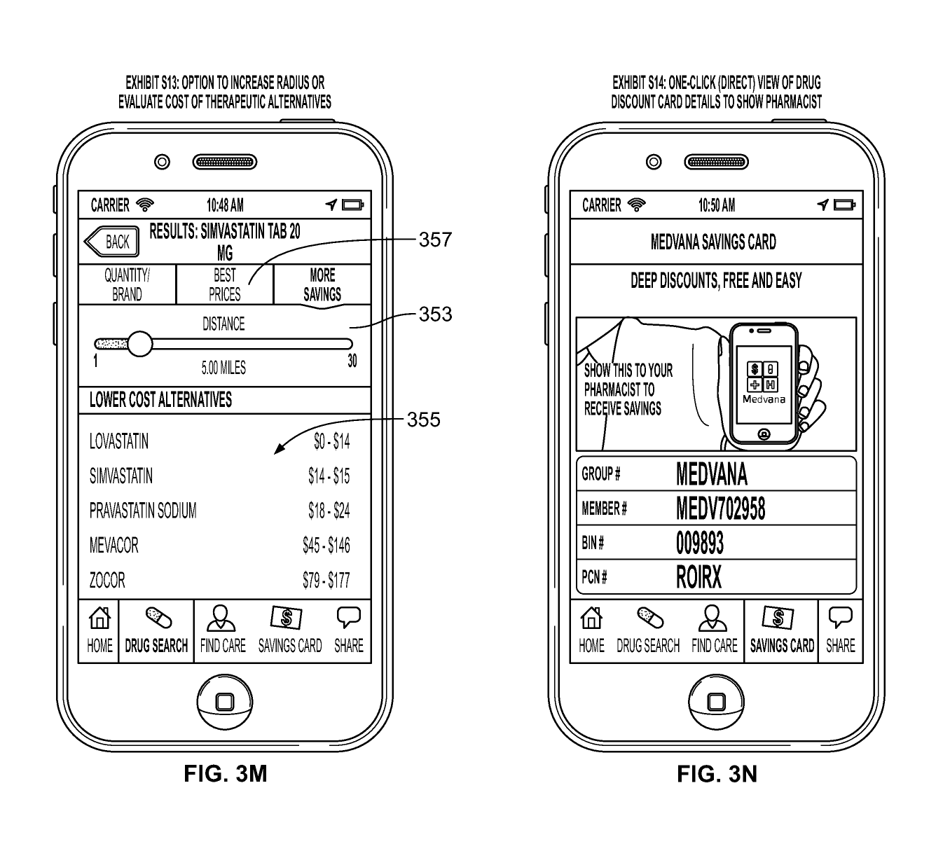

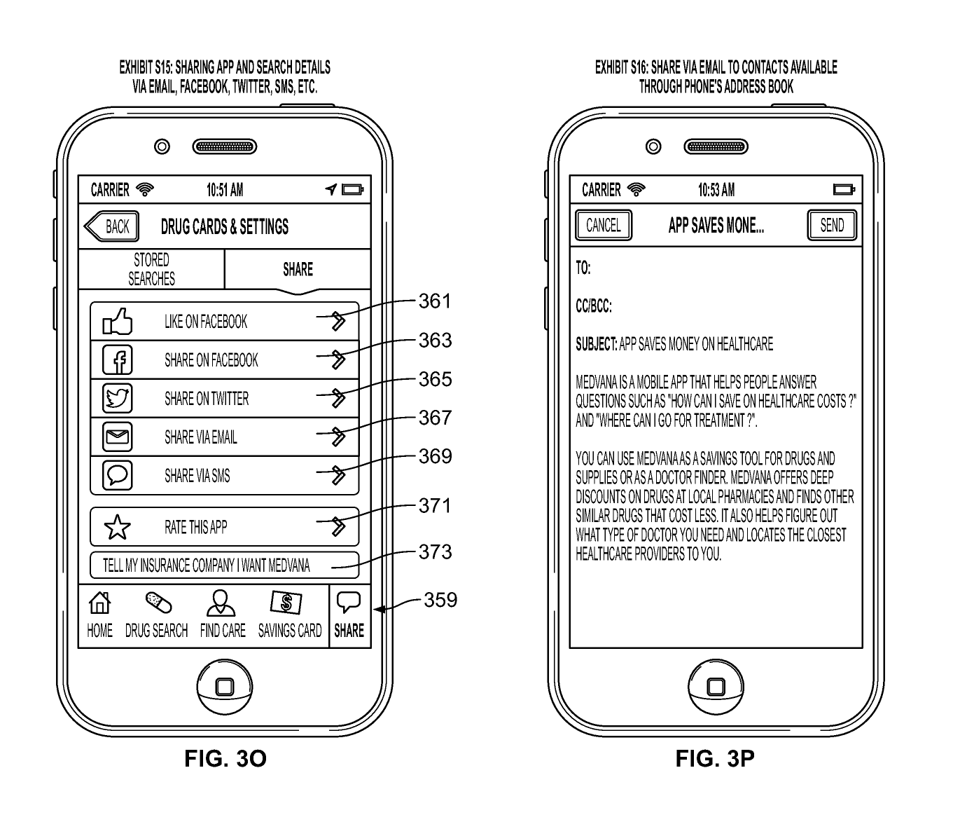

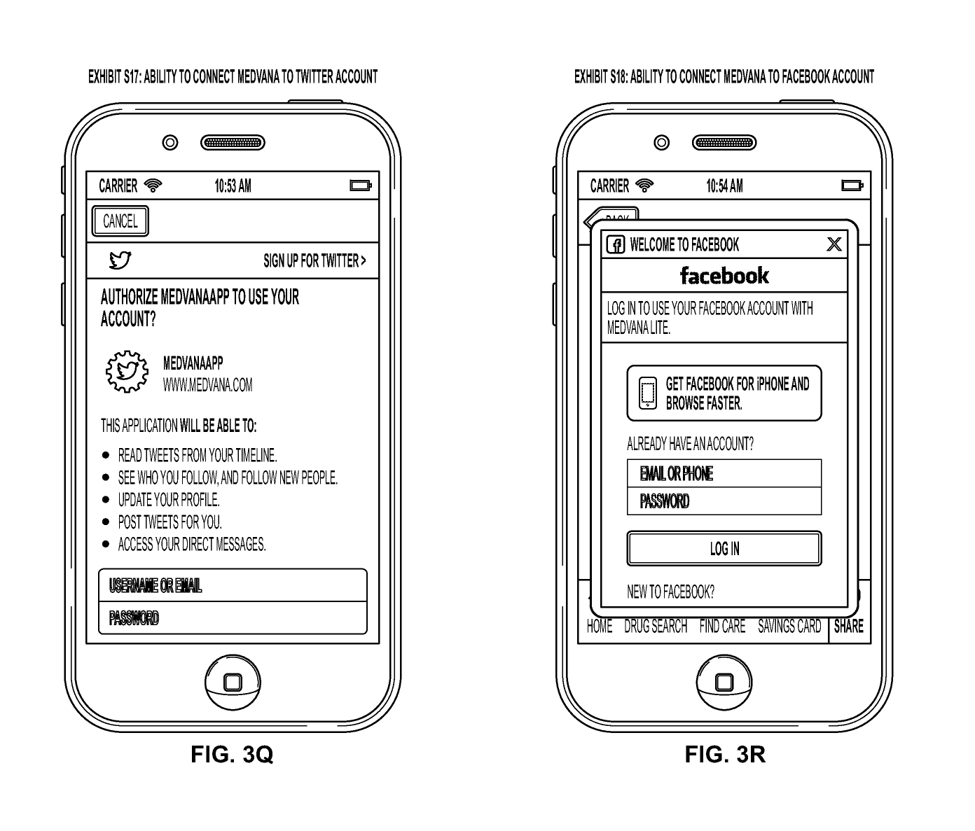

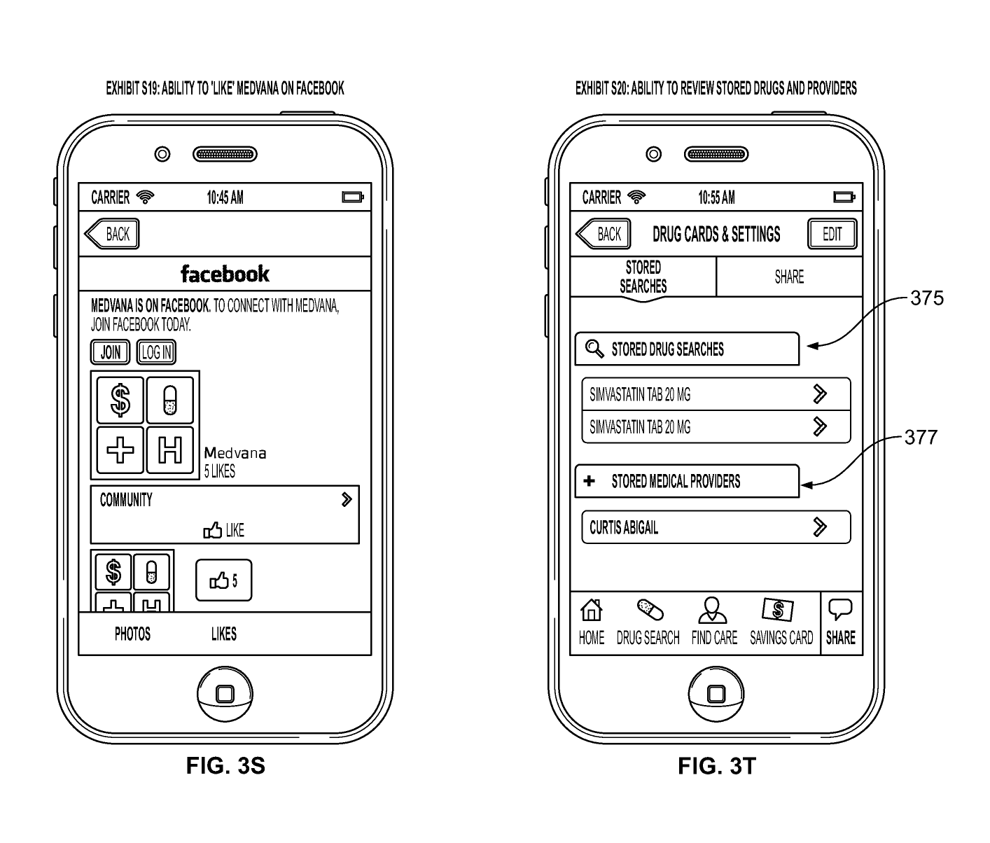

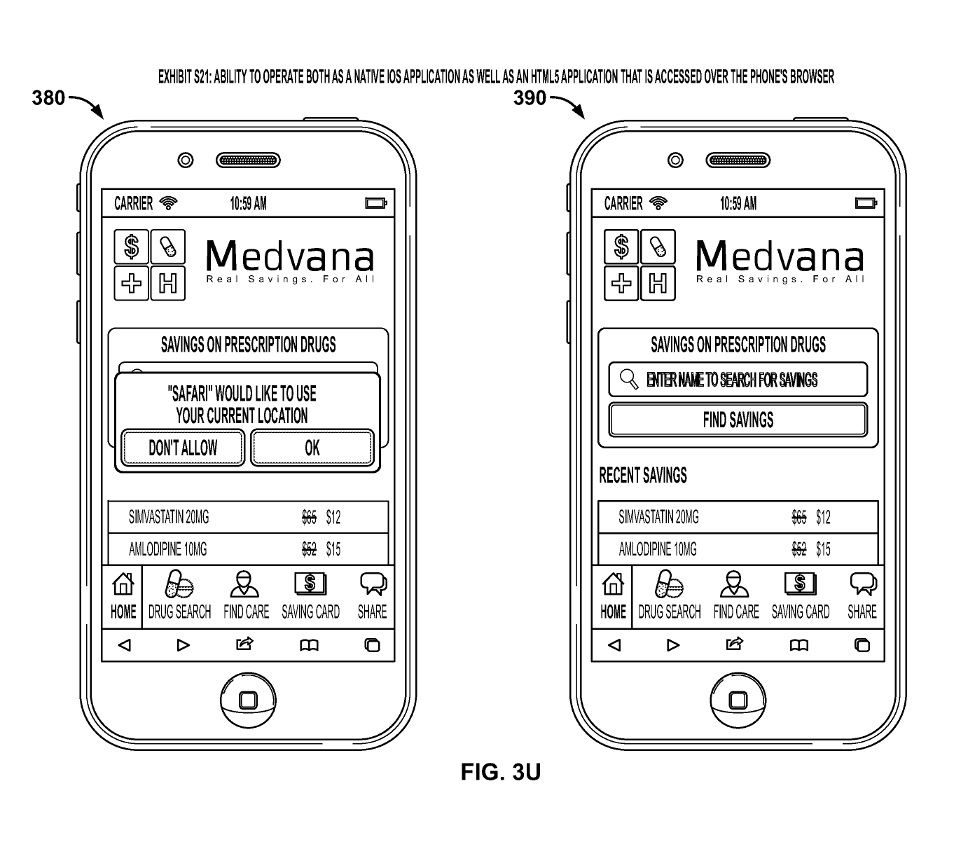

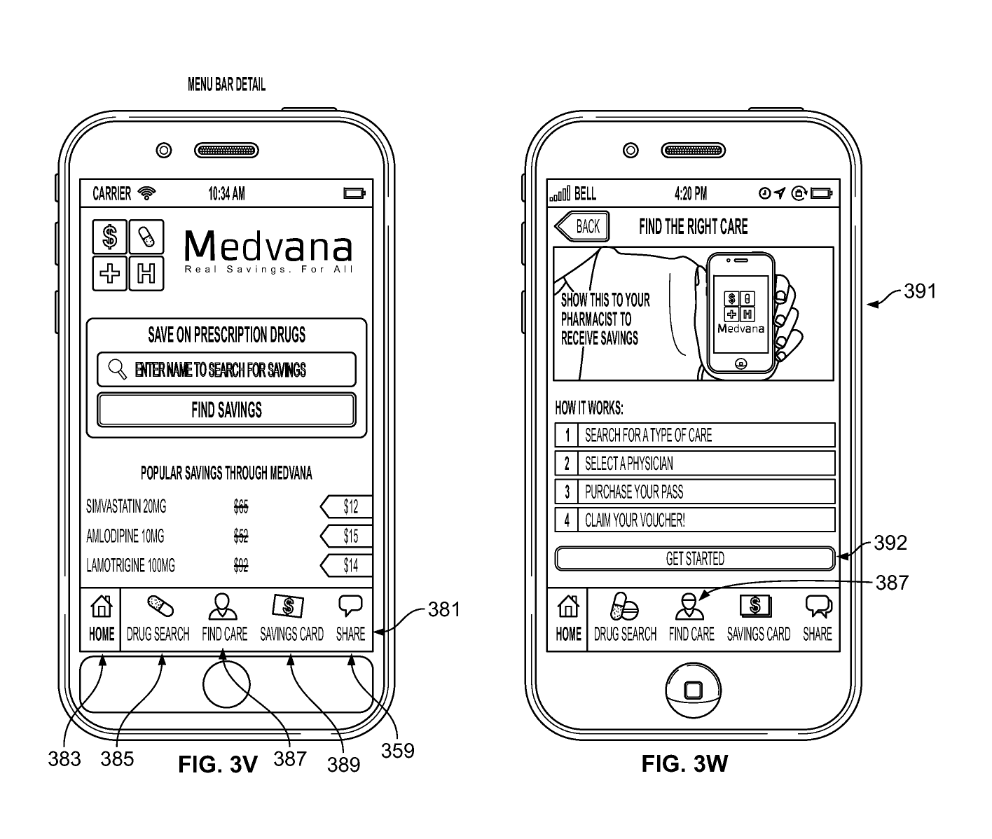

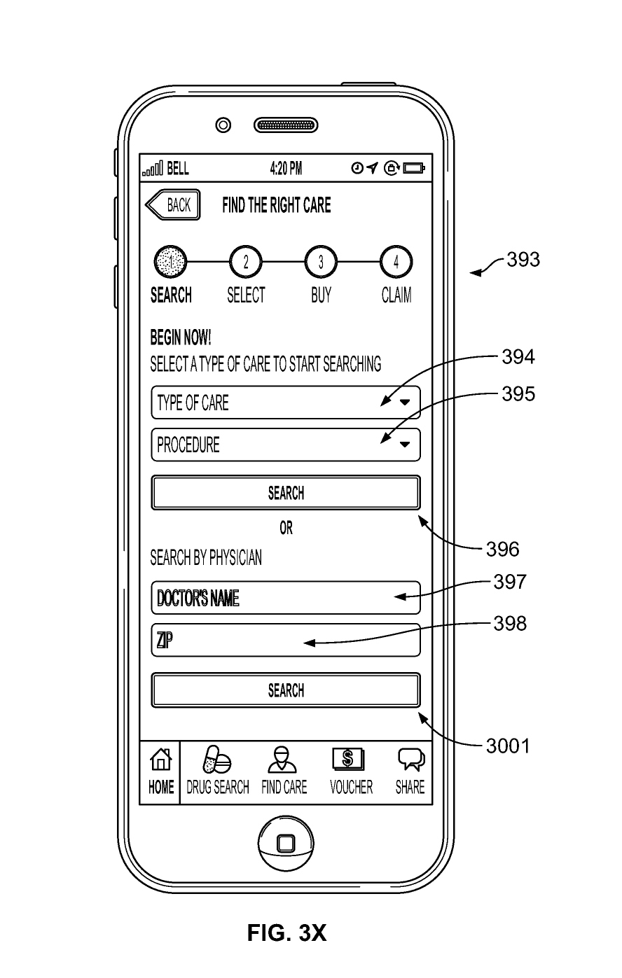

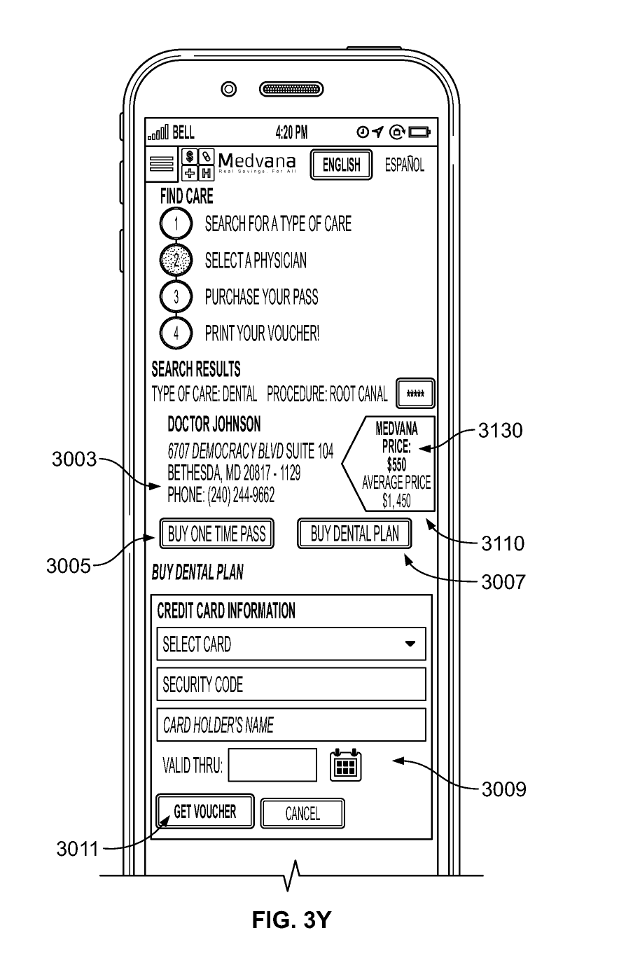

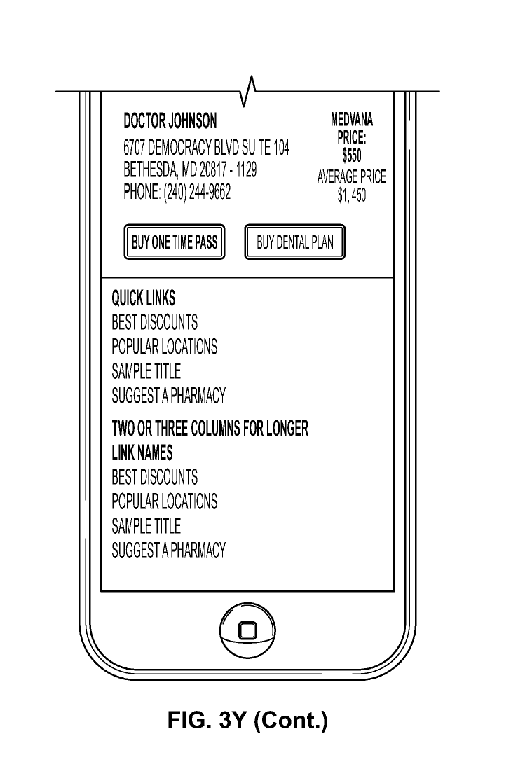

FIGS. 2A-2D show process flow algorithms of the claimed invention. FIGS. 2A-2D show some of the actions (in blocks S1 to S20) taken in methods in accordance with the claimed invention. The method can be modified to include additional actions or to include fewer actions than discussed with regard to FIGS. 2A-2D. Unless otherwise indicated, the terms “process” and “method” are used synonymously in this disclosure. FIGS. 3A-3U show screen shots of a user device 101 as the method progresses to further understand the method and system of the medical savings management application in accordance with the claimed invention.

As shown in FIGS. 2A and 3A, in some example embodiments, a medical savings application icon 302 can be selected by a user in block 51. Display 418 can serve as a touch-sensitive input device, and the icon 302 can be selected by touch. The medical savings application icon 302 is shown as “Medvana” to indicate to a user that selection of the icon 302 will allow the user to input prescription drug and pharmacy information and/or documents and receive drug pricing information and/or documents. When the medical savings application icon 302 is selected, the medical savings application opens. The medical savings application process can be launched on the user device 301 from the native application (as shown in the following example FIGS.) or from a web browser via a uniform resource locator (URL) that provides a computer network address for accessing Medvana server 151. FIG. 3U illustrates an example home page delivered by the server 151 as an HTML5 application 380 accessed over a browser on the user device 101 as well as an example home page delivered by the server 151 as a native application 390. In either case, when the Medvana server 151 is accessed, the server 151 checks a user profile and saved items database 133 to determine that the user of device 101 is permitted to perform the methods and processes of the claimed invention. In some example embodiments of the claimed invention, the Medvana server 151 can check a unique user identifier or code or the like to confirm the identity of the user.

Once the medical savings application is launched, the process continues as splash screen FIG. 3B is shown on display 418 of the user device 301 in block S2. The medical savings application requests permission to use location information to be gathered from location determining circuitry 428 of the user device (computing device 410). If the user refuses to grant permission, the application requests a city name or zip code to be provided either by the user or by the settings on the user device 101 to localize a search radius. If the user grants permission to use location information gathered, or provides the zip code or city name, the process continues and home page FIG. 3C is shown on the display 418 of the user device 101. When more than one user is associated with the particular user device 101, the server 151 can provide the display 418 of the user device 101 with a list of patients associated with the user of the computing device 410. For example, when an employee has additional family members included as beneficiaries of a prescription medicine benefit program, each family member can have associated prescriptions and associated information and/or documents shown on display 418 of the user device 301.

When the server 151 confirms that the user is permitted (or users are permitted) to access the medical savings application, a home page FIG. 3C is shown on display 418 of the user device 301 in block S3. Home page FIG. 3C includes a savings bar 303, a drug entry field 304, a search button 305 and other information and/or advertisements 306 sent from server 151 and shown on display 418 of the user device 301. The other information and/or advertisements 306 sent from server 151 can be identified based upon information in the user profile and saved items database 133, the prescription frequency database 123, the pharmacy claims database 127, the contracted drug database 135, and other databases to which the server 151 has access. The other information can include a history of past prescription drugs searched, a history of past pharmacies patronized, special pricing offers, and the like. A menu bar 381 enables users to directly access certain functions of the medical savings application that are frequently used. For example, as shown in further detail in FIG. 3V, menu bar 381 includes home button 383, drug search button 385, find care button 387, savings card button 389, and share button 359. Functions and examples of methods used with these menu bar buttons are described further below.

Returning to FIG. 2A, in block S41, a user enters a name of a prescription drug or other healthcare service in drug entry field 304. As the user enters the prescription drug name in drug field 304, server 151 can provide suggested entry completions 307a, 307b, 307c, 307d on display 418 of the user device as shown in FIG. 3D and in block S42 using drugname sorting module 221. The suggested entry completions 307a, 307b, 307c, 307d can include specific drug names, doses, formulations, and the like, or the simplest, popular tradename of a drug or service that users are likely to identify with and understand. For example, a user can enter “LIPITOR” instead of “LIPITOR 20 mg Tablets” or simply “Root Canal” instead of much longer industry terms for similar procedures.

The suggested entry completions 307a, 307b, 307c, 307d sent from server 151 can be identified based upon information in the drug listing database 121, the prescription frequency database 123, the pharmacy claims database 127, the contracted drug database 135, the therapeutic alternative and pricing range database 129, and other databases to which the server 151 has access using the drugname sorting module 221 and the therapeutic alternative module 225. The user can continue to enter the name of a prescription drug in drug entry field 304 or can select one of the suggested entry completions 307a, 307b, 307c, 307d in block S43. Once the name of the prescription drug is entered or selected from the suggested entry completions, the name of the prescription drug is shown in drug field 304. The user can then select the search button 305 to conduct a search of local pharmacies and healthcare providers for the entered prescription drug using location based search module 223. The server 151 then conducts a search for the name of the prescription drug entered as shown in FIG. 3E. The server 151 conducts the search using the drug listing database 121, the prescription frequency database 123, the pharmacy detail database 125, the pharmacy claims database 127, the therapeutic alternative and pricing range database 129, the provider director database 131, the user profile and saved items database 133, the contracted drug database 135, and other databases to which the server 151 has access.

In one example embodiment of the claimed invention, the server 151 translates the user's input drug name or medical service name into the nearest industry identifier that is used by pharmacies and PBM contracts to determine availability and price. For example, for pharmaceutical drugs, the name is translated into a National Drug Code (NDC). The server requests the therapeutic alternatives to the given drug or medical procedure and determines the group of clinical and therapeutic alternatives. The server 151 makes requests to both internal databases as well as to remote servers via APIs to assemble this information and prepare it for submission to the price adjudication system 160. The server 151 submits the request for pricing to the price adjudication system 160 for a given NDC at a specific location, at a specific radius and requests pricing for a specific number of providers. The price adjudication system 160 returns the prices at specific providers, using industry standard codes such as the National Association of Boards of Pharmacy identifiers for pharmacies. The Medvana server 151 compares the contracted pricing to the average retail price at that provider and prepares the information for display to the user.

An example of the logic, modules, and databases used to determine the average retail price at a particular provider is shown also in FIG. 2C where the claims database 2127 is used to determine a summary of prices at pharmacies by a contracted drug identifier 2117. The summary 2117 along with contracted drug identifiers 2107, and pharmacy affiliation grouping logic 2137 are provided to other logic modules, including the specific drug at pharmacy module 2147, the drug at pharmacy by affiliation module 2157. These modules 2147, 2157 along with the drug at pharmacy by affiliation and local-based parameters logic module 2167 and price estimates by therapeutic equivalence logic module 2177 are used in the roll up logic module to determine the best average price to display to a user 2187.

Returning to FIG. 2B, using drugname sorting module 221, pricing logic module 222, location based search module 223, pharmacy average pricing module 224, therapeutic alternative module 225, and filtering module 226, block S51 and FIG. 3F show a listing of local pharmacies 309a, 309b, 309c, 309d at which the entered drug can be purchased. Local pharmacies 309a, 309b, 309c, 309d can be independent “one-of” pharmacies or can be part of a chain of stores with a local presence. In block S52 the average price 311 for the each pharmacy is calculated and shown for each of the named local pharmacies 309a, 309b, 309c, 309d using pharmacy average pricing module 224. The average price 311 is determined using the drug listing database 121, and the pharmacy detail database 125 and reflects the average retail price charged by the listed pharmacy for the listed prescription drug. Millions of recent transactions from pharmacies nationwide are aggregated and averaged using a cascading algorithm that averages the most recent retail price at a specific provider, considering the owner and chain affiliations of a group and the state that provider is located, to determine or approximate what price a user would be charged at a pharmacy for a given drug if they did not have the benefit of any discounts.

In block S6, the discounted price 313 for each of the displayed the local pharmacies is determined and shown on display 418 of user device 301. The discounted price 313 is determined by the server 151 using the drug listing database 121, the pharmacy detail database 125, provider directory 131, and contracted drug database 135. Additionally, the discounted price 313 is determined using the price adjudication system 160 as shown in FIG. 1. For example, the back end database 203 access the real-time adjudication module 241 to contact price adjudication system 160 to look up the negotiated contract price of the particular listed prescription drug at that particular pharmacy. The system and method of the claimed invention can access, determine, and display a discounted price by accessing a real-time or clone adjudication system via an API. The accessing, determining, and displaying of the discounted price does not rely upon a corresponding average store price, Usual and Customary Price, or retail price. The adjudicated discount price is an agreed-upon price between the pharmacy/healthcare provider and the provider of the medical savings application and is not reliant average store price, Usual and Customary Price, and/or retail price. The listed prescription drug is sold to the user for the discounted price 313 based upon the user presenting the electronic discount card (described further below and shown in FIGS. 3H, 3I, and 3N) of the claimed invention to the pharmacy upon sale of the prescription drug.

When the local pharmacies 309a, 309b, 309c, 309d and the discounted price 313 for each pharmacy is determined and shown on display 418 of user device 301, a user can select one of the displayed local pharmacies 309a, 309b, 309c, 309d in block S7 and receive further details regarding the prescription drug and the selected pharmacy using location based search module 223 and pharmacy average pricing intelligence module 224. Selecting one of the displayed local pharmacies 309a, 309b, 309c, 309d displays pharmacy detail page FIG. 3G. Pharmacy detail page FIG. 3G shows prescription drug details 315 and a pharmacy location listing 317. The user can place a telephone call directly to the listed pharmacy by selecting the call pharmacy button 319. Call pharmacy button 319 accesses the pharmacy telephone number from provider directory database 131 and is integrated with the default telephone call functionality of the user device 101 to call the listed pharmacy.

Additionally in FIG. 3G, a pharmacy map listing 321 is shown on the display 418 of the user device 301. The user can get directions to the pharmacy by selecting get directions to pharmacy button 323. Get directions button 323 accesses the pharmacy address from the provider directory database 131 and is integrated with the default maps application of the user device 101 to display directions from the user's current location (determined with location determining circuitry 428) to the address of the pharmacy using location based search module 223. Prescription drug details 315 are determined by the server 151 based upon drug listing database 121, the prescription frequency database 123, the pharmacy detail database 125, the pharmacy claims database 127, the therapeutic alternative and pricing range database 129, the provider director database 131, the user profile and saved items database 133, the contracted drug database 135, and other databases to which the server 151 has access.

The price displayed to the user can be determined based on the contracted or discounted price and can incorporate the average retail price. Prices for pharmacies that are not in the contracted network are either excluded from the display, or placed lower on the display 418 of the user's device 101 so the user is not distracted by providers with higher prices who have been unwilling to participate in extending savings to users. The pharmacies with the lowest contracted price for the selected drug are displayed at the top of list. If a pharmacy's retail price is lower than the discounted price, the user will either see the lower retail price (e.g., $4 generic at Wal-Mart) or the higher discounted price based on pricing logic module 222 and other business logic in the back end logic 202 that are selected for that user's application. The specific pharmacy's longitude and latitude, along with its address are used to pinpoint on mapping service platforms the exact location of the pharmacy on a digital, interactive map.

Pharmacy detail page FIG. 3G shows discount card button 325. When a user selects discount card button 325, discount card summary FIG. 3H is shown on display 418 of the user device 301 as shown in block S8. Discount card summary FIG. 3H includes a displayed group number 327, a displayed member number 329, a displayed BIN number 331, and a displayed PCN number 333. The BIN number often refers to a Bank Identification Number, which routes electronic pharmacy insurance claims to pharmacy benefits managers and/or payers of the pharmacy benefits claims. The PCN number is a secondary identifier and often refers to a Processor Control Number, which can be used to differentiate different pharmacy benefits plans offered by the pharmacy benefits payer. A user can scroll down the displayed discount card summary FIG. 3H to view additional details 335 regarding the discount, including a toll free help number as shown in block S9 and in FIG. 31. Additional details can be viewed by selecting the details button 337, which loads discount card details and disclaimers FIG. 3J shown on display 418 of the user device 301 and in block S10. The electronic discount card FIG. 3H is presented by a user to the proprietor of the pharmacy at which the user is purchasing the listed drug. The electronic discount card FIG. 3H entitles the user/holder of the card to the discounted price 313 that was negotiated with the listed pharmacy on behalf of all users of the medical savings application.

The specific identifiers and codes of the discount card can vary by group or by sponsor. For example, the member identifier might simply be the user's phone number. The other design templates of the user's experience such as the logo, color scheme, sorting order of discounted prices can also vary based on the version of the medical savings application and on the specific requirements of sponsors marketing medical savings application to users. For example, one sponsor may prefer a particular color or information display field and/or graphical user interface.

Pharmacy detail page FIG. 3G also shows Store button 339 that can be selected by a user to store the selected drug and pharmacy information displayed. When a user selects store button 339, store/save screen FIG. 3K is shown on display 418 of the user device 301 and in block S11, and the prescription drug search information is stored in the user profile and saved items database 133 using saving module 227. Pharmacy detail page FIG. 3G also shows email button 341 that can be selected by a user to send an email message regarding the selected drug and pharmacy information displayed as well as the discount information from displayed discount card summary FIG. 3H. Email button 323 accesses the drug listing from drug listing database 121 and the pharmacy information from pharmacy detail database 125 and is integrated with the default electronic mail application of the user device 101 to send electronic mail messages from the user device 101 to an email address selected from a contact list on the user device 101 or otherwise input by the user.

When a user chooses to review or carry out a search that has been stored in the user profile and saved items database 133, the user can select the share button 359 shown in FIG. 3K. By selecting the share button 359, stored searches screen FIG. 3T is shown on display 418 of the user device 301 using sharing logic module 228. The user can then select from the stored drug searches 375 listed and save the search into the user profile and saved items database 133. Similarly, the user can select from the stored medical providers 377 listed from which a revised or new search can be conducted.

When a user views discounted drug prices at local contracted pharmacies FIG. 3F, in addition to selecting a particular local pharmacies 309a, 309b, 309c, 309d and discounted drug price 313, a user can also opt to change the quantity and/or the drug type by selecting quantity/brand button 343 as shown on display 418 of the user device 301 in block S12. By selecting quantity/brand button 343, options to filter FIG. 3L is shown on display 418 of the user device using filtering logic module 226, drugname sorting module 22, pricing logic module 222, and therapeutic alternative module 225. The quantities to display are based on a frequency mapping of the most common quantities prescribed nationwide using the repository of millions of pharmacy claims.

Therapeutic alternatives are determined using therapeutic alternative and pricing range database 129 in conjunction with therapeutic alternative logic module 225. As shown further in FIG. 2D, for example, therapeutic alternative logic module 225 receives the drug name and detail selected by a user in block F1. In block F2, the drug name and detail is abstracted into unique drug ingredients. The drug ingredients can include the constituent elements, components, mixtures, and/or compounds that make up the drug. In block F3, the therapeutic alternative logic determines other categories of drugs with comparable therapeutic and/or chemical equivalence to the drug name and detail provided by the user. In block F4, pricing estimates for each therapeutic and chemical equivalent are calculated in conjunction with pricing logic module 222. In block F5, the therapeutic alternative logic module 225 in conjunction with the filtering logic module 226 sorts and displays price ranges for each determined equivalent and shows the results on display 418 of the user device 301. Depending upon the prescription drug selected, the user can then choose a different quantity by selecting quantity options button 345. A user can also choose to refine the search results of discounted drug prices at local contracted pharmacies FIG. 3F by choosing a different drug type by selecting drug type slider 347 as shown in FIG. 3L. For example, a user can choose to limit the search to brand name only drugs or to expand the search to include brand name and generic drugs. The refined results can then be displayed by selecting the refresh button 349.

Additionally, the search can be refined by selecting the more savings button 351 shown in FIG. 3L. When the more savings button 351 is selected, the more savings screen FIG. 3M is shown on display 418 of the user device 301 in block S13. To refine the results, a user can move distance slide bar 353 to increase/decrease the geographical distance of searched pharmacies that carry the selected prescription drug using the location based search module 223 and filtering logic module 226 to access provider directory database 131, pharmacy detail database 125, dug listing database 121, and contracted drug database 135. As discount prices are determined, the system 101 accesses real-time adjudication system module 241 to access the price adjudication system 160. Alternatively, or additionally, users can select a lower cost alternative medication from the list 355 and perform a search for the lower cost therapeutic alternatives at local pharmacies using therapeutic alternative module 225 to access therapeutic alternative and pricing range database 129. Once a lower cost therapeutic alternative is selected, the user can present the savings card FIG. 3N to the pharmacy to receive a negotiated discount on the selected therapeutic alternative to the searched prescription drug.

Users can share savings information and details regarding cost savings, participating pharmacies, prescription drugs, and therapeutic alternatives with other users in a number of ways using sharing module 228. Users can share their results and cost savings via email and text message as well as enlist a number of social media outlets including Facebook, Twitter, and the like, to get the word out regarding successful searches, results, pharmacies, and other information regarding the search and purchase processes. For example, in block S15, a user can select the share button 359 and the sharing screen FIG. 3O will be shown on display 418 of the user device 301 using sharing module 228. When the sharing screen FIG. 3O is shown, a user can select to like 361 the medical savings application on Facebook, share 363 the medical savings application on Facebook, share 365 the medical savings application on Twitter, share 367 the medical savings application via email, and share 369 the medical savings application via text message (such as by SMS or other text messaging service) using wireless messaging platform 213. Users can also rate 371 the medical savings application and tell their insurance company about the medical savings application by selecting insurance button 373.

For example, when a user chooses to share 367 via email, the sharing module 228 provides an email message FIG. 3P regarding the medical savings application using the default email program on the user's computing device 410. The user can then edit, address, and send the email to share the benefits of the medical savings application. Likewise, when a user chooses to share 365 via Twitter, the system 100 provides a Twitter posting format FIG. 3Q authorizing the medical savings application to access and use the user's Twitter account on the user's computing device 410. The user can then create, post, and tweet characters to share the benefits of the medical savings application.

Similarly, when a user chooses to like 361 or share 363 on Facebook, the system 100 provides a Facebook login page FIG. 3R authorizing the medical savings application to use the user's Facebook account with the medical savings application on the user's computing device 410. The system 100 also provides the medical savings application details FIG. 3S on Facebook for selection by the user. The user can then like or share the medical savings application to promote its benefits to other social media users.

When a user chooses to rate 371 the medical savings application, they can rate via the application store from which they installed the medical savings application, or they can send feedback to Medvana regarding the application. When a user chooses to rate the application via the application store, a rating information page (not shown separately) is provided using sharing module 228 and is shown on display 418 of the user device 301 providing rating, feedback, and review templates with which to rate the medical savings application.

Flex Cards

As outlined above, the claimed invention provides an additional level of discounts for users via tax advantages afforded by “flex cards” that are part of health reimbursement accounts (HRA), health savings accounts (HSA), and/or flexible spending accounts (FSA). Flex cards are tied to these tax-advantaged accounts and often resemble credit cards, including MasterCard, Visa, and the like. Flex cards in accordance with the system and method of the claimed invention provide users the ability to check their outstanding balance or deductible, file a claim, or make a payment at the pharmacy or healthcare provider using pretax contributions on the flex cards. For example, using the medical savings application of the claimed invention, users receive discounts on prescription drugs, medical supplies, and medical treatments. A prescription drug that retails for $100 might instead cost $20 using the medical savings application of the claimed invention. Tying a flex card to the claimed invention provides an additional level of discounts via tax advantages.

HRAs, HSAs, and/or FSAs are predominantly used by patients and users on high-deductible or consumer-driven health plans. Although these users tend to have insurance through their employers, the system and method of the claimed invention enables users to file a claim and make a payment at a pharmacy or healthcare provider using a flex card through a user device to take advantage of the pre-tax treatment of these accounts. An electronic flex card can be presented to the pharmacy in addition to the electronic discount card or electronic coupon (Medvana Savings Card) described below.

The flex card, regular credit cards/debit cards, and payroll debit and pre-paid rewards cards can be used over the phone or over the web. Users benefit from the use of these cards for the tax advantages of the contribution and/or for the convenience of not having to pay with cash for eligible medical expenses (e.g., dental work).

Electronic Coupons

Additionally, as the systems and methods of the claimed invention are used for medical supplies and medical treatments, users are provided access to purchase coupons, including medical passes (e.g., one-time dental/lab/imaging discount) and medical plans (e.g., monthly dental discount plans) that are not insurance plans but allow users to access low rates from healthcare providers.

As shown in one example embodiment of the claimed invention in FIG. 3W, a user can select the find care button 387 on the user device 301, and the Find the Right Care splash screen 391 will be shown on display 418 of the user device 301. Once a user reads the splash screen and selects the get started button 392, the find the right care search screen 393 shown in FIG. 3X will be shown on display 418 of the user device 301. A user can enter the type of care needed in block 394 and/or the procedure needed in block 395 or can select a type of care needed from a list of healthcare services that will drop down. A user can then initiate the search by selecting the search button 396. Alternatively, a user can search for a particular physician by entering the doctor's name in block 397 or a zip code in block 398 and selecting the search button 3001.

As shown in FIG. 3Y, the search will bring up a search result listing 3003 of one or more doctors and the average price 3110 as well as the adjudicated discount price 3130 for the particular medical service or medical supply. A user can then choose to take advantage of the discounted price for this particular medical service by purchasing a one time pass by selecting one time pass button 3005. Alternatively, the user can opt to purchase a discounted medical service plan (in this example, a discounted dental plan) by selecting dental plan button 3007. In the example shown in FIG. 3Y, the user selected buy dental plan 3007, and additional information regarding payment information 3009 for the selected dental plan will be shown on display 418 of the user device 301. The user can then enter payment information, such as credit card information, debit card information, reward card, or other electronic payment form. Once the payment information is entered, the user can select get voucher button 3011, and the voucher (that is, the electronic coupon) will be generated.

The electronic coupon of the claimed invention provides the user with a lower rate for the healthcare service or supply purchased than would typically be available in a retail exchange. The electronic coupon leverages the buying power of a group to access low rates from healthcare providers.

Plan Comparison

In addition, the system and method of the claimed invention allows users to select the insurance plan they are in or plan to purchase (for example, on an exchange) and compute what the users' overall out-of-pocket expense will be on prescription drugs and other medical expenses. The system and method of the claimed invention then determines the specific drugs, medical supplies, and/or medical services for which the users are better off using the electronic discount card of the claimed invention (because the discounted rates available with the electronic discount card are below the user's plan's copay, or cover drugs, devices or services not covered by the plan). The plan comparison capabilities of the claimed invention allows the upselling of discount plans, medical supplies, and medical services and allows the system and method of the claimed invention to recommend specific insurance plans that would be suitable/optimal for the user.

Using the methods, system, and devices of the claimed invention, a patient or other user wants can determine the discount price of a prescription drug or other medical treatment in a particular locality. The device presents discounted pricing for the selected prescription drug or service at select local providers when a user presents an electronic discount card. The discount card can be provided for free or paid for by the user. The directory of local providers can be mapped for the users using a GPS or location determination device. Users can identify and price clinical, therapeutic, and functional alternatives based on additional search criteria including service type, device classification, dosage, package, manufacturer, effects, price, and the like. Where a user needs to purchase a plan to access the savings, select plans are offered and promoted to the user.

The claimed invention provides a second level of discounts for users via tax advantages afforded by flex cards that are part of health reimbursement accounts (HRA), health savings accounts (HSA), and/or flexible spending accounts (FSA). Flex cards tied to the systems and methods of the claimed invention provide users the ability to file a claim and make a payment at the pharmacy or healthcare provider using pretax contributions on the flex cards.

Systems and methods in accordance with the claimed invention are used to purchase coupons, including one-time medical discount passes and/or discounted medical plans that are not insurance but allow users to access low rates from healthcare providers by leveraging the buying power of a group to access low rates from healthcare providers.

In addition, the system and method of the claimed invention allows users to select and compare insurance plans in which they are members or are planning to become members and compute the user's likely out-of-pocket expenses for prescription drugs, medical supplies, and medical services. The systems and methods of the claimed invention then determine the specific drugs, medical supplies, and/or medical services for which the users are better off using the electronic discount card of the claimed invention because the discounted rates available with the electronic discount card are below the user's plan's copay, or the discounted rates available with the electronic discount card cover drugs, devices or services not covered by the user's plan.

Having thus described the basic concept of the invention, it will be apparent to those skilled in the art that the detailed disclosure is intended to be presented by way of example only, and is not limiting. Various alterations, improvements, and modifications will occur and are intended to those skilled in the art, though not expressly stated in this document. These alterations, improvements, and modifications are intended to be suggested by this document, and are within the spirit and scope of the invention. Additionally, the recited order of processing elements or sequences, or the use of numbers, letters, or other designations therefore, is not intended to limit the claimed processes to any order except as can be specified in the claims. Accordingly, the invention is limited only by the following claims and equivalents thereto.

The claimed invention is:

1. A method of operating a computing device to provide medical savings, the method comprising:
receiving a healthcare service description entry from an application running in conjunction with the computing device;
receiving a location of the computing device;
locating a healthcare service listing from a database, the healthcare service listing corresponding to the received healthcare service description from the application running in conjunction with the computing device;
locating a healthcare provider of the listed healthcare service based upon the received location of the computing device;
determining an average price for the healthcare service at the healthcare provider; and
determining an adjudicated price for the healthcare service at the healthcare provider where the adjudicated price is a negotiated discount price that users of the computing device pay to the healthcare provider for the healthcare service.

2. The method of operating a computing device to provide medical savings of claim 1, wherein the healthcare service includes a prescription drug.

3. The method of operating a computing device to provide medical savings of claim 2 further comprising:
determining a therapeutic alternative for the prescription drug;
determining an average price for the therapeutic alternative at the healthcare provider; and
determining an adjudicated price for the therapeutic alternative at the healthcare provider where the adjudicated price is a negotiated discount price that users of the computing device pay to the healthcare provider for the therapeutic alternative.

4. The method of operating a computing device to provide medical savings of claim 3, wherein determining the therapeutic alternative for the prescription drug comprises:
abstracting the prescription drug into constituent drug ingredients using at least one of a therapeutic alternative logic module and a therapeutic alternative and pricing range database;
determining a category of drug with at least one of comparable therapeutic equivalence and comparable chemical equivalence to the prescription drug with at least one of the therapeutic alternative logic module and the therapeutic alternative and pricing range database; and
calculating pricing estimates for the at least one therapeutic and chemical equivalent with pricing logic module.

5. The method of operating a computing device to provide medical savings of claim 1, wherein the adjudicated price is a contracted price for the healthcare service at the healthcare provider where the contracted price is a negotiated discount price that the healthcare provider agrees to charge users of the computing device for the healthcare service.

6. The method of operating a computing device to provide medical savings of claim 1 further comprising:
providing an electronic discount card to the computing device to confirm the user of the computing device is entitled to receive the adjudicated price for the healthcare service at the healthcare provider.

7. The method of operating a computing device to provide medical savings of claim 6, wherein the electronic discount card is at least one of a coupon or pass.

8. The method of operating a computing device to provide medical savings of claim 1 further comprising:
storing the healthcare service listing, the healthcare provider, and the adjudicated price for the healthcare service at the healthcare provider in a user profile and saved items database.

9. The method of operating a computing device to provide medical savings of claim 1 further comprising:
sharing the healthcare service listing, the healthcare provider, and the adjudicated price for the healthcare service at the healthcare provider with a sharing logic module by at least one of email, text message, and social media outlet.

10. The method of operating a computing device to provide medical savings of claim 1 further comprising:
locating a plurality of healthcare providers of the listed healthcare service based upon the received location of the computing device;
determining an average price for the healthcare service at each of the plurality of healthcare providers; and
determining an adjudicated price for the healthcare service at each of the healthcare providers where each of the adjudicated prices is a negotiated discount price that users of the computing device pay to each healthcare provider for the healthcare service.

11. The method of operating a computing device to providing medical savings of claim 10, wherein locating the plurality of healthcare providers of the listed healthcare service is based upon the received location of the computing device.

12. The method of operating a computing device to provide medical savings of claim 1 further comprising:
providing at least one of an advertisement, a description of frequent medical services purchased, a prescription, and a medical history to the computing device.

13. The method of operating a computing device to provide medical savings of claim 1 further comprising:
receiving sales information of the healthcare service at the healthcare provider for the adjudicated price;
providing the sales information to at least one of a discount card provider, insurance provider, pharmacy benefits manager, and healthcare manager; and
tracking healthcare compliance based upon the sales information.

14. An electronic computing device comprising tangible, machine-readable media, comprising code executable to perform the steps of:
transmitting a healthcare service description entry from a medication savings application running on the computing device;
transmitting location information of the computing device;
receiving a healthcare service listing from a database, the healthcare service listing corresponding to the transmitted healthcare service description from the application running on the computing device;
receiving healthcare provider information for the healthcare service based upon the transmitted location of the computing device;
accessing an average price for the healthcare service at the healthcare provider; and
accessing an adjudicated price for the healthcare service at the healthcare provider where the adjudicated price is a negotiated discount price that users of the computing device pay to the healthcare provider for the healthcare service.

15. The electronic computing device comprising tangible, machine-readable media of claim 14, further comprising code executable to perform the steps of:
estimating savings across multiple healthcare plan options that a user can access based on discounted rates negotiated by each healthcare plan option and the user's expected use of healthcare services.

16. The electronic computing device comprising tangible, machine-readable media of claim 15, further comprising code executable to perform the steps of:
paying for at least one of a discount plan, coupon, or pass to gain access to the discounted rates.

17. The electronic computing device comprising tangible, machine-readable media of claim 16, wherein payment is made with at least one of a flex card, credit card, debit card, pre-paid card, or electronic payment.
